(19) United States
(12) Patent Application Publication
(10) Pub. No.: US 2025/0092589 A1
(43) Pub. Date: Mar. 20, 2025

(54) LONG CUT CELLULOSE ACETATE STAPLE FIBERS FOR FILL MATERIALS

(71) Applicant: Eastman Chemical (China) Co., Ltd, Pudong New District, Shanghai (CN)

(72) Inventors: Dnyanada Shankar Satam, Boca Raton, FL (US); Brian Tyndall Edwards, Jonesborough, TN (US); Emily Baird Anderson, Kingsport, TN (US); Wen Ying Qiu, Shanghai (CN); Yi Hui Wu, Shanghai (CN); Heather Grandelli Quigley, Johnson City, TN (US); Pevas Domonic Bailey, Kingsport, TN (US)

(73) Assignee: Eastman Chemical (China) Co., Ltd, Pudong New District, Shanghai (CN)

(21) Appl. No.: 18/729,632

(22) PCT Filed: Jan. 19, 2022
(86) PCT No.: PCT/CN2022/072707

§ 371 Date: Jul. 17, 2024

(51) Int. Cl. D04H 1/02; D01F 2/28; D04H 1/4258; D04H 1/4266; D04H 1/4382

(52) U.S. Cl. CPC D04H 1/02; D01F 2/28; D04H 1/4258; D04H 1/4266; D04H 1/43835; D10B 2201/28; D10B 2211/04; D10B 2505/00

(57) ABSTRACT

Long cut cellulose acetate staple fibers having cut lengths of 55 mm or greater can be used to readily form fiber blends with silk fibers. Additionally, the long cut cellulose acetate fibers may be used to form fill materials for filled articles, which can be produced from the fiber blends or formed entirely from the long cut cellulose acetate fibers. Due to their unique properties, the long cut cellulose acetate fibers may partially or entirely replace silk fibers in various applications.

### BACKGROUND

### 1. Field of the Invention

The present disclosure generally relates to fiber blends useful as a fill material for filled articles and/or insulation. More particularly, the present disclosure relates to fiber blends containing cellulose acetate fibers, which can be used as a filler material for various textiles.

### 2. Description of the Related Art

Different varieties of silk may be used in premium bedding products as a fill fiber. Generally, silk is recognized as a premium natural fiber, which has inherent attributes beneficial for one's heath and skin. The natural luster and soft, sleek, hand-feel of the silk fiber also provides a high-quality appearance to the fiber.

Typically, the cross-section of most varieties of silk (e.g., tasar, muga, and eri) is cylindrical or flat. Due to this flat cross-section, silk-filled duvets can be used for winter duvets only when the fill component volume is increased to provide better warmth; thus, this increases the weight of the duvet. Additionally, due to the flat cross-section of the silk fiber, the resulting fill batting made with 100 percent silk generally has low loft and compression resistance as compared to batting made with synthetic fibers. Silk is temperature regulating and is moisture wicking compared to cotton, allowing for a cool and comfortable sleep or garment wear experience. Moreover, silk fibers may be more prone to bacterial growth for some strains of bacteria and/or allergy issues compared to synthetic fibers. Furthermore, maintenance of silk duvets is also tedious as such products have to be handwashed only and dried flat. Lastly, silk production is also associated with a high carbon footprint.

Thus, there is a need in the art to provide alternative and/or improved fill materials for garment and household applications that do not suffer from one or more of these drawbacks associated with silk fibers. There is also a need to maintain or to improve the production capability and the beneficial properties of silk materials, including temperature regulation, moisture management, luster, odor management, and soft, sleek, hand-feel and fabric pilling or deformation capability for a cool-to-touch or comfortable sleep or garment wear experience. An alternative and/or improved fill material can change strength of the material and shape retention or deformation capability.

The present disclosure addresses this need as well as others, which will become apparent from the following description and the appended claims.

### SUMMARY

One or more embodiments of the present disclosure generally concern a fiber blend comprising: (a) a cellulose acetate staple fiber, wherein the cellulose acetate staple fiber has a cut length of at least 55 mm and (b) at least 25 weight percent of a silk fiber.

One or more embodiments of the present disclosure generally concern a fiber blend comprising: (a) a cellulose acetate staple fiber, wherein the cellulose acetate staple fiber comprises a cut length of greater than 150 mm; and (b) an optional secondary fiber.

One or more embodiments of the present disclosure generally concern a fill material for use in filled articles and/or insulation. Generally, the fill material comprises: (a) at least 95 weight percent of a cellulose acetate staple fiber, wherein the cellulose acetate staple fiber has a cut length of at least 55 mm; and (b) an optional secondary fiber.

One or more embodiments of the present disclosure generally concern a filled article comprising an outer fabric layer and a fill material disposed within the outer fabric layer. Generally, the fill material comprises: (a) a blend of silk fibers and cellulose acetate staple fibers, wherein the blend comprises at least 25 weight percent of the silk fibers, (b) a first fiber material comprising at least 95 weight percent of cellulose acetate staple fibers having a cut length of at least 55 mm, and/or (c) a second fiber material comprising cellulose acetate staple fibers having a cut length of at least 150 mm.

### DETAILED DESCRIPTION

It has been surprisingly discovered that fiber blends and/or fill materials comprising cellulose acetate fibers with longer cut lengths can be used to replace conventional blends and fill materials containing silk fibers. More particularly, it has been discovered that cellulose acetate fibers with sufficiently long cut lengths may be used to replace at least a portion of or all of the silk fibers generally used in fill materials. For example, it has been discovered that the non-round cross-sectional shapes of the cellulose acetate fibers may provide better loft and compression resistance to a fill material, particularly compared to a fill material made from silk fibers. More specifically, the long cut cellulose acetate fibers may be crimped, unlike silk fibers that are flat and uncrimped, which may improve the loft, compression resistance, and recovery of the resulting fill material made from the cellulose acetate fibers. In addition, it has been discovered that the longer cut cellulose acetate fibers can exhibit a silk-like hand-feel to the fill material, thereby minimizing or completely avoiding the need to add silk fibers to the fill material. Furthermore, it has also been discovered that the longer cut cellulose acetate fibers may more easily be blended with silk fibers.

It has also been surprisingly discovered that fill materials made entirely (i.e., 100 weight percent) of cellulose acetate fibers with sufficiently long cut lengths may provide an economic alternative to fill materials made entirely with silk fiber. It has been observed that fill materials made with longer cut cellulose acetate fibers may exhibit a superior insulation performance, as demonstrated by their breathability, moisture and thermal management, and comfort. Moreover, unlike fill materials containing silk fibers, fill materials made entirely (i.e., 100 weight percent) of long cut cellulose acetate fibers lengths can be machine washed, thus providing a low maintenance fill material. Additionally, in contrast to silk fibers, cellulose acetate fibers may resist different bacterial strains from growing than silk and improve the hypoallergenic nature of the blend or fill material.

As described below in greater detail, the long cut cellulose acetate fibers of the present disclosure can have a cut length of greater than 55 mm, more particularly a cut length greater than 96 mm, or even more particularly a cut length greater than 150 mm. In addition, the long cut cellulose acetate fibers may be crimped, comprise a non-round cross-sectional shape, and contain a denier per filament of at least 1.2.

It should be noted that all of the following embodiments, although listed separately, may be readily combined in any combination to the extent that such combination does not cause a contradiction. For example, one skilled in the art would readily appreciate that the separately-listed cut length ranges of the cellulose acetate fibers could be readily and easily combined with any of the following cross-sectional shapes, denier ranges, and performance properties disclosed herein.

### The Long Cut Cellulose Acetate Fibers

Useful cellulose acetate (CA) staple fibers are described in International Patent Application No. PCT/US2018/019995 filed on Feb. 27, 2018; the entire contents of which is hereby incorporated by reference. To the extent that any incorporated subject matter contradicts with any disclosure herein, the disclosure herein takes precedence over the incorporated content.

The cellulose acetate fibers may be formed from cellulose

diacetate, cellulose triacetate, or mixtures thereof. The cellulose acetate can have a degree of substitution ranging from 1.9 to less than 3. As used herein, the term “degree of substitution” or “DS” refers to the average number of acyl substituents per anhydroglucose ring of the cellulose polymer, wherein the maximum degree of substitution is 3.0. In one embodiment or in any of the mentioned embodiments, the cellulose acetate may have an average degree of substitution of at least 1.95, 2.0, 2.05, 2.1, 2.15, 2.2, 2.25, or 2.3 and/or not more than 2.9, 2.85, 2.8, 2.75, 2.7, 2.65, 2.6, 2.55, 2.5, 2.45, 2.4, or 2.35. The DS may also fall within one or more of the above ranges (e.g., from 2.2 to 2.8).

In one embodiment or in any of the mentioned embodiments, at least 90, 91, 92, 93, 94, 95, 96, 97, 98, or 99 percent of the cellulose acetate has a DS of greater than 2.15, 2.2, or 2.25. Additionally, or alternatively, in one embodiment or in any of the mentioned embodiments, at least 90 percent of the cellulose acetate can have a DS of greater than 2.2, 2.25, 2.3, or 2.35. Typically, acetyl groups can make up at least 1, 5, 10, 15, 20, 25, 30, 35, 40, 45, 50, 55, or 60 percent and/or not more than 99, 95, 90, 85, 80, 75, or 70 percent of the total acyl substituents.

The cellulose acetate may have a weight-average molecular weight (Mw) of not more than 90,000, measured using gel permeation chromatography with N-methyl-2-pyrrolidone (NMP) as the solvent. In one embodiment or in any of the mentioned embodiments, the cellulose acetate may have a Mw of at least 10,000, at least 20,000, 25,000, 30,000, 35,000, 40,000, or 45,000 and/or not more than 100,000, 95,000, 90,000, 85,000, 80,000, 75,000, 70,000, 65,000, 60,000, or 50,000.

The cellulose acetate may be formed by any suitable method. In one embodiment or in any of the mentioned embodiments, the cellulose acetate may be formed by reacting a cellulosic material, such as wood pulp, with acetic anhydride and a catalyst in an acidic reaction medium to form a cellulose acetate flake. The flake may then be dissolved in a solvent, such as acetone or methyl ethyl ketone, to form a “solvent dope,” which can be filtered and sent through a spinnerette to form cellulose acetate fibers. In certain embodiments, up to 1 weight percent or more of titanium dioxide or other delusterant may be added to the dope (based on the total weight of the dope) prior to filtration, depending on the desired properties and ultimate end-use of the fibers. Alternatively, less than 1, 0.5, or 0.1 weight percent of titanium dioxide or other delusterant may be added to the dope (based on the total weight of the dope) prior to filtration. When incorporated into a fiber, textile, or a fabric made of cellulose acetate, titanium dioxide can provide acceptable UV protection and increase the UV resistance of the final fiber blend, textile, or fabric. This addition of UV additive is enabled by the dope and spinning process and not easily incorporated into silk natural fibers.

In one embodiment or in any of the mentioned embodiments, the solvent dope or flake used to form the cellulose acetate fibers may include few or no additives in addition to the cellulose acetate. Such additives can include, but are not limited to, plasticizers, antioxidants, thermal stabilizers, pro-oxidants, acid scavengers, inorganics, pigments, and/or colorants.

In one embodiment or in any of the mentioned embodiments, the cellulose acetate fibers can comprise at least 90, 90.5, 91, 91.5, 92, 92.5, 93, 93.5, 94, 94.5, 95, 95.5, 96, 96.5, 97, 97.5, 98, 98.5, 99, 99.5, 99.9, 99.99, 99.995, or 99.999 percent of cellulose acetate, based on the total weight of the fiber. In certain embodiments, fibers formed according to the present disclosure may include not more than 10, 9.5, 9, 8.5, 8, 7.5, 7, 6.5, 6, 5.5, 5, 4.5, 4, 3.5, 3, 2.5, 2, 1.5, 1, 0.5, 0.1, 0.01, 0.005, or 0.001 weight percent of one or more additives, including the specific additives listed herein.

At the spinnerette, the solvent dope can be extruded through a plurality of holes to form continuous cellulose acetate filaments. The filaments may be gathered together to form bundles of several hundred, or even thousand, individual filaments. Each of these bundles, or bands, may include at least 100, 150, 200, 250, 300, 350, or 400 and/or not more than 1000, 900, 850, 800, 750, or 700 fibers. The spinnerette may be operated at any speed suitable to produce filaments and bundles having desired size and shape.

Multiple bundles may be assembled into a filament yarn, such as a crimped or uncrimped tow band. As used herein, a “filament yarn” or “tow yarn” refers to a yarn formed from a plurality of continuous, untwisted individual filaments. The filament yarn may be of any suitable size and, in one embodiment or in any of the mentioned embodiments, may have a total denier of at least 20,000, 25,000, 30,000, 35,000, 40,000, 45,000, 50,000, 75,000, 100,000, 150,000, 200,000, 250,000, 300,000, 350,000, 400,000, 450,000, or 500,000. Alternatively, or in addition, the total denier of the filament yarn can be no more than 5,000,000, 4,500,000, 4,000,000, 3,500,00, 3,000,000, 2,500,000, 2,000,000, 1,500,000, 1,000,000, 900,000, 800,000, 700,000, 600,00, 500,000, 400,000, 350,000, 300,000, 250,000, 200,000, 150,000, 100,000, 95,000, 90,000, 85,000, 80,000, 75,000, or 70,000.

The individual filaments, which are extruded in a generally longitudinally aligned manner and which ultimately form the filament yarn, may also be of any suitable size. For example, each cellulose acetate filament may have a linear denier per filament (weight in g of 9000 m fiber length) of at least 0.1, 0.5, 1, 1.5, 2, 2.5, 3, 4, or 5 and/or not more than 30, 25, 20, 15, 14, 13, 12, 11, 10, 9, 8, 7, 6, 5, 4.5, 4, 3, or 2.75, as measured according to ASTM D1577-01 using the FAVIMAT vibroscope procedure. As used herein, the term “filament” refers to an elongated, continuous single strand fiber and is distinguished from a staple fiber, which has been cut to a specified length, as described in further detail below.

The individual filaments discharged from the spinnerette and the resulting cellulose acetate staple fibers may have any non-round cross-sectional shape. Exemplary cross-sectional shapes include, but are not limited to, Y-shaped, I-shaped (dog bone), closed C-shaped, tri-lobal, multi-lobal, X-shaped, or crenulated. When a filament or staple fiber has a multi-lobal cross-sectional shape, it may have at least 4, 5, or 6 or more lobes. In one embodiment or in any of the mentioned embodiments, the filaments or staple fibers may be symmetric along one or more, two or more, three or more, or four or more axes, and, in other embodiments, the filaments or staple fibers may be asymmetrical.

In one embodiment or in any of the mentioned embodiments, the cellulose acetate staple fibers may have a Y-shaped cross-sectional shape, a closed-C cross-sectional shape, a crenulated cross-sectional shape, or a tri-lobal cross-sectional shape. As used herein, the term “cross-section” or variations thereof generally refer to the transverse cross-section of the filament measured in a direction perpendicular to the direction of elongation of the filament or staple fiber. The cross-section of the filament or staple fiber may be determined and measured using Quantitative Image Analysis (QIA). Staple fibers may have a cross-sectional shape similar or identical to the filaments from which they were formed.

The cross-sectional shape of an individual filament or staple fiber may be characterized according to its deviation from a round cross-sectional shape. In one embodiment or in any of the mentioned embodiments, this deviation can be characterized by the shape factor of the filament or fiber, which is determined by the following formula: Shape Factor=Perimeter/(4π×Cross-Sectional Area)^{1/2}. In one embodiment or in any of the mentioned embodiments, the shape factor of the individual cellulose acetate filaments or fibers can be at least 1.01, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2, 2.25, 2.5, 2.75, 3, or 3.25 and/or not more than 5, 4.8, 4.75, 4.5, 4.25, 4, 3.75, 3.5, 3.25, 3, 2.75, 2.5, 2.25, 2, 1.75, 1.5, or 1.25. (Note: these values may also be expressed as ratios of the listed numbers to 1—e.g., 1.45:1.) The shape factor of a filament or fiber having a round cross-sectional shape is 1. The shape factor can be calculated from the cross-sectional area of a filament or fiber, which can be measured using QIA.

Additionally, the cross-sectional shape of the filament or fiber may also be compared to a round cross-section according to its equivalent diameter, which is the equivalent diameter of a round filament or fiber having a cross-sectional area equal to a given filament or fiber. In one embodiment or in any of the mentioned embodiments, the cellulose acetate filaments or fibers can have an equivalent diameter of at least 0.0022, 0.0023, 0.0024, 0.0025, 0.0030, 0.0033, 0.0035, 0.0040, 0.0045, 0.0050, 0.0055, 0.0060, 0.0065, 0.0070, 0.0073, 0.0075, 0.0080, 0.0085, 0.0090, 0.0095, 0.0100, 0.0103, 0.0104, 0.0105, 0.0110, 0.0112, 0.0115, 0.0120, 0.0125, 0.0126, 0.013, 0.014, or 0.015 mm. Alternatively, or in addition, the cellulose acetate filaments or fibers may have an equivalent diameter of not more than 0.0400, 0.0375, 0.036, 0.0359, 0.0350, 0.0033, 0.0327, 0.0325, 0.0300, 0.0275, 0.0250, 0.0232, 0.0225, 0.0200, 0.0179, 0.0175, 0.016, 0.0150, 0.0127, 0.0125, or 0.0120 mm. The equivalent diameter is calculated from the cross-section of a filament or fiber, measured using QIA. The cross-sectional shape of the fiber may facilitate the blending properties and final properties of the fiber blend.

The filament yarn (or tow yarn) may be passed through a crimping zone, where a patterned wavelike shape is imparted to at least a portion, or substantially all, of the individual filaments.

The crimping zone includes at least one crimping device for mechanically crimping the filament yarn. An example of a mechanical crimper includes a “stuffing box” or “stuffer box” crimper that uses a plurality of rollers to generate friction, which causes the fibers to buckle and form crimps inside the box. Other types of crimpers may also be used. Examples of equipment suitable for imparting crimp to a filament yarn are described in, for example, U.S. Pat. Nos. 9,179,709; 2,346,258; 3,353,239; 3,571,870; 3,813,740; 4,004,330; 4,095,318; 5,025,538; 7,152,288; and 7,585,442, the disclosures of which are incorporated herein by reference. To the extent that any incorporated subject matter contradicts with any disclosure herein, the disclosure herein takes precedence over the incorporated content. In one embodiment or in any of the mentioned embodiments, the crimping step may be performed at a rate of at least 50, 75, 100, 125, 150, 175, 200, 225, or 250 meters per minute (m/min) and/or not more than 750, 600, 550, 500, 475, 450, 425, 400, 375, 350, 325, or 300 m/min.

In one embodiment or in any of the mentioned embodiments, low crimp, low denier per filament (DPF) cellulose acetate fibers may be formed that exhibit minimal breakage and a high degree of retained tenacity. As used herein, the term “retained tenacity” refers to the ratio of the average tenacity of a crimped filament or fiber to the average tenacity of an identical but uncrimped filament or fiber, expressed as a percent. For example, a crimped fiber having a tenacity of 1.3 gram-force/denier (g/denier) would have a retained tenacity of 87 percent if an identical but uncrimped fiber had a tenacity of 1.5 g/denier.

In one embodiment or in any of the mentioned embodiments, the crimped cellulose acetate filaments or fibers may have a retained tenacity of at least 50, 55, 60, 65, 70, 75, 80, 85, 90, 95, 97, or 99 percent. Additionally, or in the alternative, the retained tenacity of the cellulose acetate filaments or fibers may be no more than 99, 97, 95, 90, 92, 90, 87, 85, 82, or 80 percent, calculated as described herein. In certain embodiments, the retained tenacity may be 100 percent. Crimped filaments or fibers exhibiting a retained tenacity in these ranges is unexpected in light of the inherent weakness of most cellulose acetate filaments.

In one embodiment or in any of the mentioned embodiments, the final cellulose acetate staple fibers may exhibit similar retained tenacities as compared to identical but uncrimped staple fibers.

Crimping is performed such that the final cellulose acetate staple fibers have a crimp frequency of at least 3, 4, 5, 6, 7, 8, 9, 10, 11, 12, 13, or 14 and/or not more than 30, 29, 28, 27, 26, 25, 24, 23, 22, 21, 20, 19, 18, 17, 16, 15, 14, 13, 12, 10, 9, 8, 7, or 6 crimps per inch (CPI), measured according to ASTM D3937. In certain embodiments, the cellulose acetate staple fibers may have a crimp frequency in the range of 3 to 30, 5 to 30, or 10 to 30 CPI.

The crimp frequency of the crimped filament yarn may also fall within one or more of the above ranges (e.g., 10-30, 15-25, etc.), although the crimped filament yarn may have similar, or slightly different, values for crimp frequency than the staple fibers formed from cutting the filament yarn. For example, in one embodiment or in any of the mentioned embodiments, the difference between the crimp frequency of the filament yarn and the staple fibers formed from that filament yarn may be at least 0.5, at least 1, or at least 1.5 CPI and/or not more than 5, not more than 2.5, not more than 2, not more than 1.5, not more than 1, or not more than 0.75 CPI. In one embodiment or in any of the mentioned embodiments, when measured on a filament yarn, the crimp frequency can be measured in at least 5 different locations along the filament yarn. Typically, these locations can be spaced apart from one another and from the ends of the filament yarn by at least one-half inch.

According to some embodiments, the ratio of the crimp frequency to the linear denier per filament of the individual filaments or staple fibers can be greater than 2.75:1, 2.80:1, 2.85:1, 2.90:1, 2.95:1, 3.00:1, 3.05:1, 3.10:1, 3.15:1, 3.20:1, 3.25:1, 3.30:1, 3.35:1, 3.40:1, 3.45:1, or 3.50:1. In one embodiment or in any of the mentioned embodiments, this ratio may be even higher, such as, for example, greater than 4:1, 5:1, 6:1, 7:1, 8:1, 9:1 or even 10:1 particularly when, for example, the filaments or staple fibers being crimped are relatively fine.

The crimp amplitude of the fibers or filaments may vary and can be, for example, at least 0.85, 0.90, 0.91, 0.92, 0.93, 0.94, 0.95, 0.96, 0.97, 0.98, 0.99, 1.00, 1.01, 1.02, 1.03, 1.04, or 1.05 mm. Additionally, or in the alternative, the crimp amplitude of the fibers or filaments may be not than 1.75, 1.70, 1.65, 1.60, 1.58, 1.55, 1.50, 1.45, 1.40, 1.37, 1.35, 1.30, 1.29, 1.28, 1.27, 1.26, 1.25, 1.24, 1.23, 1.22, 1.21, 1.20, 1.19, 1.18, 1.17, 1.16, 1.15, 1.14, 1.13, 1.12, 1.11, 1.10, 1.09, 1.08, 1.07, 1.06, 1.05, 1.04, 1.03, 1.02, 1.01, 1.00, 0.99, 0.98, 0.97, 0.96, 0.95, 0.94, 0.93, 0.92, 0.91, or 0.90 mm.

After crimping, the filament yarn may further be dried in a drying zone in order to reduce the moisture and/or solvent content of the filament yarn. In one embodiment or in any of the mentioned embodiments, the drying performed in the drying zone may be sufficient to reduce the final moisture content of the filament yarn to at least 3.5, 4, 4.5, 5, 5.5, 6, 6.5, or 7 weight percent, based on the total weight of the filament yarn and/or not more than 9, 8.5, 8, 7.5, 7, or 6.5 weight percent. Any suitable type of dryer can be used in the drying zone such as, for example, a forced air oven, a drum dryer, or a heat setting channel. The dryer may be operated at any temperature and pressure conditions that provide the requisite level of drying without damaging the filament yarn. A single dryer may be used, or two or more dryers may be used in parallel or in series to achieve the desired final moisture content.

Once dried, the filament yarn may be baled in a baling zone, and the resulting bales may be introduced into a cutting zone, where the filament yarns may be cut into staple fibers. As used herein, the term “staple fiber” refers to a fiber cut from a filament yarn that has a discrete length, which is typically less than 500 mm. In one embodiment or in any of the mentioned embodiments, the cellulose acetate staple fibers of the present disclosure may be cut to a length of at least 55, 56, 57, 58, 59, 60, 61, 62, 63, 64, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, or 425 mm. Additionally, or in the alternative, the staple fibers may have a cut length of not more than 600, 575, 550, 525, 500, 475, 450, 425, 400, 375, 350, 325, 300, 295, 290, 285, 280, 275, 270, 265, 260, 255, 250, 245, 240, 235, 230, 225, 220, 215, 210, 205, 200, 195, 190, 185, 180, 175, 170, 165, 160, 155, 150, 145, 140, 135, 130, 125, 120, 115, 110, 105, or 100 mm.

In one embodiment or in any of the mentioned embodiments, the cellulose acetate staple fibers of the present disclosure may have a cut length in the range of 55 to 500 mm, 95 to 500 mm, 95 to 475 mm, 125 to 475 mm, 150 to 475 mm, 160 to 280 mm, 175 to 475 mm, 190 to 475 mm, 200 to 280, mm, or 210 to 260 mm.

It should be noted that the vast majority of the cellulose acetate staple fibers may have a uniform cut length. As used herein, a “uniform cut length” means that at least 90 percent of the cellulose acetate staple fibers have a cut length that is within (i.e., ±) 2 mm of a designated cut length. For example, cellulose acetate staple fibers having a uniform cut length of 150 mm would mean that at least 90 percent of the cellulose acetate staple fibers have a cut length within a range of 148 to 152 mm. It should be noted that this “uniform cut length” can apply to any of the cut length ranges disclosed herein. Fibers of different cut lengths and properties may be blended during processing to provide a cellulose acetate with a tailored broad or narrow distribution of cut lengths and to control the change in properties of the final fiber blend. The average, breadth of the distribution, and/or ratio of cut lengths changes the ease of blending with silk or other fibers and the final properties of the blend.

Any suitable type of cutting device may be used that is capable of cutting the filaments to a desired length without excessively damaging the fibers. Examples of cutting devices can include, but are not limited to, rotary cutters, guillotines, stretch breaking devices, reciprocating blades, and combinations thereof. Once cut, the staple fibers may be baled or otherwise bagged or packaged for subsequent transportation, storage, and/or use. The cut length of the cellulose acetate staple fibers may be measured according to ASTM D-5103.

In one embodiment or in any of the mentioned embodiments, the cellulose acetate staple fibers may have a denier per filament (DPF) of at least 0.5, 1.0, 1.1, 1.2, 1.5, 2.0, or 2.5 and/or not more than 12, 11, 10, 9, 8, 7, 6, 5, 4, or 3. More particularly, in certain embodiments, the cellulose acetate staple fibers can have a DPF in the range of 0.5 to 12, 1.0 to 10, or 1.2 to 8.

The cellulose acetate staple fibers (or filament yarns used to form such fibers) may be at least partially coated with at least one fiber finish. As used herein, the terms “fiber finish” and “finish” refer to any suitable type of coating that, when applied to a fiber, modifies friction exerted by and on the fiber, and alters the ability of the fibers to move relative to one another and/or relative to a surface. Finishes are not the same as adhesives, bonding agents, or other similar chemical additives which, when added to fibers, prevent movement between the fibers by adhering them to one another. Finishes, when applied, continue to permit the movement of the fibers relative to one another and/or relative to other surfaces, but may modify the ease of this movement by increasing or decreasing the frictional forces. In one embodiment or in any of the mentioned embodiments, finishes may not modify the frictional forces between fibers, but can, instead, impart one or more other desirable properties to the final coated fiber.

In one embodiment or in any of the mentioned embodiments, the cellulose acetate staple fibers may include at least two finishes applied to all or a portion of the staple fiber surface at one or more points during the fiber production process. In other cases, the cellulose acetate staple fibers may only include one finish while, in other cases, the fibers may not include any finish at all. When two or more finishes are applied to the fibers, the finishes may be applied as a blend of two or more different finishes, or the finishes may be applied separately at different times during the process. For example, In one embodiment or in any of the mentioned embodiments, the staple fibers may be at least partially coated with a spinning or spin finish applied to the filament yarn at one or more points during the process of forming the staple fibers. Alternatively, or in addition, the spinning finish may be added to the filament yarn just prior to the crimping step or anywhere between the spinning and crimping steps. In one embodiment or in any of the mentioned embodiments, no spinning finish may be applied.

Any suitable method of applying the spinning finish may be used and can include, for example, spraying, wick application, dipping, or use of squeeze, lick, or kiss rollers. When used, the spinning finish may be of any suitable type and can be present on the filaments or staple fibers in an amount of at least 0.05, 0.10, 0.15, 0.20, 0.25, 0.30, 0.35, 0.40, 0.45, 0.50, 0.55, 0.60, 0.70, 0.80, 0.90, or 1 percent finish-on-yarn (FOY). Alternatively, or in addition, the spinning finish may be present in an amount of not more than 1.5, 1.4, 1.3, 1.2, 1.1, 1.0, 0.90, 0.80, 0.75, 0.70, 0.65, 0.60, or 0.50 percent finish-on-yarn (FOY) based on the total weight of the dried fiber. As used herein “FOY” or “finish on yarn” refers to the amount of finish on the staple fiber or filament, yarn less any added water. One or two or more types of spinning finishes may be used. In one embodiment or in any of the mentioned embodiments, the spinning finish may be hydrophobic.

Additionally, or in the alternative, the cellulose acetate staple fibers may include a top-coat finish added after crimping to impart certain properties or characteristics to the filaments. The top-coat finish may be added at one or more points during the formation of the staple fibers, including, for example, after the crimper, before the cutter, or after the cutter. When applied, the total amount of top-coat finish on the staple fibers or filament yarn may be at least 0.05, 0.10, 0.15, 0.20, 0.25, 0.30, or 0.35 and/or not more than 7, 6.5, 6, 5.5, 5, 4.5, 4, 3.5, 3, 2.5, 2, 1.5, 1.4, 1.3, 1.2, 1.1, 1.0, 0.90, 0.80, 0.75, 0.70, 0.65, 0.60, 0.55, 0.50, 0.45, 0.40, 0.35, 0.30, or 0.25 percent FOY, based on the total weight of the dried fiber or filament yarn. The fiber may include one or two or more types of top-coat finishes. In one embodiment or in any of the mentioned embodiments, no top-coat finish may be used, while, in other embodiments, the top-coat finish may be applied even when no spinning finish is applied. In some embodiments when no spinning finish is applied, the fiber may include at least one ionic top-coat finish and may include not more than 0.05, 0.01, or 0.005 percent FOY, or 0 percent FOY of a mineral oil-based finish.

The top-coat finish may be ionic or non-ionic, and ionic can be a cationic or an anionic finish. The finish may be in the form of a solution, an emulsion, or a dispersion. The top-coat finish may be applied to the fibers or filament yarn according to any known method, including those discussed previously with respect to the spinning finish. In one embodiment or in any of the mentioned embodiments, the top-coat finish may be an aqueous emulsion and it may or may not include any type of hydrocarbon, oil including silicone oil, waxes, alcohol, glycol, or siloxanes. Examples of suitable top-coat finishes can include, but are not limited to, phosphate salts, sulfate salts, ammonium salts, and combinations thereof. Minor amounts of other components, such as surfactants, may also be present in order to enhance the stability and/or processability of the finish, and/or to make it more desirable for the intended end use of the fiber (e.g., non-irritating when the fiber will be contacted with a user's skin). Further, depending on the end use of the coated staple fibers, the finish may be compliant with various Federal and state regulations and can be, for example, non-animal, Proposition 65 compliant, and/or FDA food contact approved.

The specific type of top-coat finish applied to the filaments or fibers may depend, at least in part, on the final application for which the staple fibers will be used. In one embodiment or in any of the mentioned embodiments, the top-coat finish may enhance the frictional forces between the fibers (or filaments) and/or with other surfaces that contact the fiber (or filaments), while, in other embodiments, the frictional forces between fibers and/or other surfaces may be reduced by the top-coat finish. Additionally, the finishes may impact the interaction of the coated fiber with water by modifying the hydrophilicity or hydrophobicity of the uncoated fiber to make it more or less hydrophilic or more or less hydrophobic. Use of a top-coat finish may or may not impart additional moisture to the fiber itself. In one embodiment or in any of the mentioned embodiments, addition of the top-coat finish results in less than 1.0, 0.90, 0.80, 0.70, 0.60, 0.50, 0.40, 0.30, or 0.20% FOY moisture added to the uncoated fiber or filament.

In one embodiment or in any of the mentioned embodiments, it has been found that top-coat finishes that enhance fiber-to-fiber friction as compared to an identical but uncoated fiber may be desirable for fibers of relatively low (e.g., not more than 8 CPI) or no crimp frequency, while, in other cases, it has been found that fibers having relatively higher crimp frequency (e.g., 16 CPI or higher) may benefit from top-coat finishes that either do not modify or reduce fiber-to-fiber friction as compared to an identical but uncoated fiber. In one embodiment or in any of the mentioned embodiments, fibers having a crimp frequency in the range of from 8 to 16 CPI or 10 to 14 CPI may be processed with no top-coat finish. In certain cases, only a top-coat finish may be applied to the fibers.

Further, in one embodiment or in any of the mentioned embodiments, the top-coat (and/or spinning) finish may include other additives such as, for example, an anti-static agent. In addition, the finish may also include one or more other additives such as a wetting agent, antioxidants, biocides, anti-corrosion agents, pH control agents, emulsifiers, and combinations thereof. It is also possible that one or more additives may be added to a fiber as a coating, but without additional friction-modifying properties. For example, an antistatic agent may be applied to a fiber that does not otherwise include a top-coat finish and may be suitably formed into a fill material as described herein.

When present, any suitable anti-static agent may be used. In one embodiment or in any of the mentioned embodiments, the anti-static agent may include polar and/or hydrophilic compounds. When used, such additives may be present in any suitable amount such as, for example, at least 0.10, 0.15, 0.20, 0.25, 0.30, or 0.35 weight percent and/or not more than 3, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, 1, 0.90, 0.80, 0.70, 0.60, or 0.50 weight percent, based on the total weight of the finish.

When the cellulose acetate staple fibers are coated with an anti-static finish, the coated fiber may exhibit a static half-life of not more than 100, 90, 80, 75, 70, 65, 60, 55, 50, 45, 40, 35, 30, 25, 22, 20, 17, 15, 12, 10, 8, 5, 3, 2, 1.5, or 1 seconds, measured according to AATCC 84-2011. In one embodiment or in any of the mentioned embodiments, the cellulose acetate staple fibers may have a static half-life of not more than 30, 25, 20, 18, 15, 12, 10, or 8 minutes. In other embodiments, the static half-life of the coated fiber may be at least 30 seconds, at least 1 minute, at least 5, 8, 10, 15, 20, 30, 40, 50, 60, 75, 90, or 100 minutes and/or not more than 120, 110, 100, 90, 75, 60, 45, 40, 35, 30, 20, 15, or 12 minutes, measured according to AATCC 84-2011.

In one embodiment or in any of the mentioned embodiments, this may be not more than 95, 90, 85, 80, 75, 70, 65, 60, 55, 50, 45, 40, 35, 30, 25, 20, 15, 10, or 5 percent of the static half-life of an identical but uncoated fiber. In one embodiment or in any of the mentioned embodiments, the static half-life of the coated fiber may be at least 5, 10, 15, 20, 25, 30, 35, 40, 45, 50, 55, 60, 65, 70, 75, 80, 85, 90, or 95 percent less than the static half-life of an identical but uncoated fiber.

Alternatively, or in addition, the coated cellulose acetate staple fibers may have a surface resistivity (Log R) of at least 2, 2.5, 3, 3.5, 4, 4.5, 5, 5.5, 6, 6.5, 7, 7.5, 8, 8.5, or 9 and/or not more than 11, 10.5, 10, 9.75, 9.5, 9.25, 9, 8.75, 8.5, 8.25, 8, 7.75, 7.5 measured according to AATCC TM76-2011. The surface resistivity was measured using a Monroe Electronics resistivity meter (Model No. 272A) connected to a Keithley Instruments isolation box (Model No. 6104) using an isolation cup for measuring the resistivity of the staple fibers. The surface resistivity (Log R) is calculated by multiplying the surface resistance by the ratio of the length of the area being tested to its width and expressing the result as the base 10 logarithm of the calculated value.

In one embodiment or in any of the mentioned embodiments, the cellulose acetate staple fibers or filament yarns may be at least partially coated with at least one spinning finish and at least one top-coat finish. The total amount of all finishes present on the staple fibers or filament yarns can be at least 0.15, 0.20, 0.25, 0.30, 0.35, 0.40, 0.45, 0.50, 0.55, 0.60, 0.65, 0.70, 0.75, 0.80, 0.85, 0.90, 0.95, 1.0, or 1.05 percent FOY and/or not more than 10, 9, 8, 7, 6, 5, 4, 3, 2, 1.5, 1.4, 1.3, 1.2, 1.1, 1.0, 0.90, 0.80, 0.75, 0.70, 0.65, 0.60, 0.55, 0.50, or 0.45 percent FOY, based on the total weight of the dried fiber. The amount of finish on the fibers as expressed by weight percent may be determined by solvent extraction according to ASTM D2257.

The coated staple fibers may exhibit a fiber-to-fiber (F/F) staple pad coefficient of friction (SPCOF) of at least 0.10, 0.15, 0.20, 0.25, 0.30, 0.32, 0.35, 0.40, 0.42, 0.45, 0.50, 0.55 and/or not more than 1, 0.95, 0.90, 0.85, 0.80, 0.75, 0.70, 0.65, 0.60, 0.55, 0.50, 0.45, 0.40, or 0.35, measured as described in U.S. Pat. No. 5,683,811, modified as below.

A staple pad of the fibers whose friction is to be measured is sandwiched between a weight on top of the staple pad and a base that is underneath the staple pad and is mounted on the lower crosshead of an Instron 5966 Blue Hill machine (product of Instron Engineering Corp., Canton, Mass) with Series IX software. The staple pad is prepared by carding the staple fibers (using a roller top laboratory card) to form a batt which is cut into sections, that are 12 inches in length and 3 inches wide, with the fibers oriented in the length dimension of the batt. Enough sections are stacked up so the staple pad weighs 3 grams. The metal weight on top of the staple pad is of length (L) 100 mm, width (W) 45 mm, and height (H) 40 mm, and weighs 1200 grams. The surfaces of the weight and of the base that contact the staple pad are covered with 60 GC sandpaper attached with doubled sided tape, so that it is the sandpaper that contacts the surfaces of the staple pad. The staple pad is placed on the base. The weight is placed on the middle of the pad. A nylon monofil line is attached to one of the smaller vertical (W×H) faces of the weight and passed around a small pulley up to the upper crosshead of the Instron, making a 90-degree wrap angle around the pulley.

A computer interfaced to the Instron is given a signal to start the test. The lower crosshead of the Instron is moved down at a speed of 150 (+/−30) mm/min. The staple pad, the weight and the pulley are also moved down with the base, which is mounted on the lower crosshead. Tension increases in the nylon monofil as it is stretched between the weight, which is moving down, and the upper crosshead, which remains stationary. Tension is applied to the weight in a horizontal direction, which is the direction of orientation of the fibers in the staple pad. Initially, there is little or no movement within the staple pad. The force applied to the upper crosshead of the Instron is monitored by a load cell and increases to a threshold level, when the fibers in the pad start moving past each other. (Because of the Emery cloth at the interfaces with the staple pad, there is little relative motion at these interfaces; essentially any motion results from fibers within the staple pad moving past each other.) The highest friction force level indicates what is required to overcome the fiber-to-fiber static friction and is recorded. The lowest friction force is the dynamic friction force. The average friction force is the average of static and dynamic friction force.

Four values are used to compute the average friction force (average load at 20-60 mm peel extension). The staple pad fiber-to-fiber coefficient of friction is determined by dividing the measured average friction force by the 1200 gm weight. The scroop value could be determined as the difference between static and dynamic friction force.

Additionally, or in the alternative, the coated staple fibers may exhibit a fiber-to-metal (F/M) staple pad coefficient of friction (SPCOF) of at least 0.10, 0.12, 0.15, 0.17, 0.20, 0.22, 0.25, 0.30, 0.32 0.35, 0.40, 0.42, 0.45, 0.48, 0.50, 0.55, 0.60 and/or not more than 1, 0.95, 0.90, 0.85, 0.80, 0.75, 0.70, 0.65, 0.60, 0.55, 0.50, 0.45, 0.40, 0.37, 0.35, 0.32, or 0.30, measured as described in measured as described in U.S. Pat. No. 5,683,811, modified as above and with the exception that the 1200-gram metal weight surface is not covered with the staple pad or the sandpaper when measuring the fiber-to-metal SPCOF.

The fiber-to-fiber cohesion of the coated staple fibers may be described by the “scroop value,” exhibited by the coated fiber. The scroop value, measured as the difference between static and dynamic pulling forces, of the coated fibers described herein can be less than 160 grams-force (g). In one embodiment or in any of the mentioned embodiments, the coated staple fibers may exhibit a scroop value of at least 10, 15, 20, 25, 30, 35, 40, 45, 50, 55, 60, 65, 70, 75, 80, 85, 90, 95, 100, 105, 110, 115, 120, or 150 grams-force (gf) and/or not more than 275, 250, 200, 195, 190, 185, 180, 175, 170, 165, 160, 155, 150, 145, 140, 135, 130, 125, 120, 115, 110, 105, or 100 gf. Coated staple fibers with lower cohesion, as indicated by a lower scoop values, may form nonwoven materials with an overall softer feel.

The static and dynamic friction (in gram-force) and the resulting scroop value may be calculated from the staple pad friction method described in U.S. Pat. Nos. 5,683,811 and 5,480,710, but using an Instron 5500 series machine, rather than an Instron 1122 machine. The fiber-to-fiber static friction is determined as described in the '710 patent as the maximum threshold pulling force at low pulling speed upon reaching equilibrium pulling behavior, and the fiber-to-fiber dynamic friction is similarly calculated, but is the minimum threshold level of force as the staple pad traverses a slip-stick behavior. The scroop is calculated as the difference between static and dynamic friction pulling forces with units of gram-force.

The coated staple fibers may also exhibit higher-than-expected strength. For example, In one embodiment or in any of the mentioned embodiments, the coated staple fibers may be formed from filaments that exhibit a tenacity of at least 0.5, 0.55, 0.60, 0.65, 0.70, 0.75, 0.80, 0.85, 0.90, 0.95, 1.0, 1.05, 1.1, 1.15, 1.20, 1.25, 1.30, or 1.35 grams-force/denier (g/denier) and/or not more than 2.50, 2.45, 2.40, 2.35, 2.30, 2.25, 2.20, 2.15, 2.10, 2.05, 2.00, 1.95, 1.90, 1.85, 1.80, 1.75, 1.70, 1.65, 1.60, 1.55, 1.50, 1.47, 1.45, or 1.40 g/denier, measured according to ASTM D3822. Additionally, in one embodiment or in any of the mentioned embodiments, the elongation at break of the coated staple fibers (or filaments from which the staple fibers are formed) can be at least 5, 6, 10, 15, 20, or 25 percent and/or not more than 50, 45, 40, 35, or 30 percent, measured according to ASTM D3822.

Traditionally, cellulose acetate fibers and filaments are coated with a plasticizer in order to facilitate formation and ultimate biodegradability of the final fibrous article. However, the fibers and filament yarns according to the invention can include little or no plasticizer and can unexpectedly exhibit enhanced biodegradability under industrial, home, and soil conditions, even as compared to cellulose acetate fibers with higher levels of plasticizer. The addition of cellulose acetate fibers to a fiber blend may change the biodegradability and compostability of that fiber blend, which is optionally changed by addition of a plasticizer.

In one embodiment or in any of the mentioned embodiments, the cellulose acetate fibers can include not more than 30, 27, 25, 22, 20, 17, 15, 12, 10, 9.5, 9, 8.5, 8, 7.5, 7, 6.5, 6, 5.5, 5, 4.5, 4, 3.5, 3, 2.5, 2, 1.5, 1, 0.5, 0.25, or 0.10 percent of plasticizers, based on the total weight of the fiber, or the fibers may include no plasticizer. When present, the plasticizer may be incorporated into the fiber itself by being blended with the solvent dope or cellulose acetate flake, or the plasticizer may be applied to the surface of the fiber or filament by spraying, by centrifugal force from a rotating drum apparatus, or by an immersion bath.

Examples of plasticizers that may or may not be present in or on the fibers can include, but are not limited to, aromatic polycarboxylic acid esters, aliphatic polycarboxylic acid esters, lower fatty acid esters of polyhydric alcohols, and phosphoric acid esters. Further examples can include, but are not limited to, dimethyl phthalate, diethyl phthalate, dibutyl phthalate, dihexyl phthalate, dioctyl phthalate, dimethoxyethyl phthalate, ethyl phthalylethyl glycolate, butyl phthalylbutyl glycolate, tetraoctyl pyromellitate, trioctyl trimellitate, dibutyl adipate, dioctyl adipate, dibutyl sebacate, dioctyl sebacate, diethyl azelate, dibutyl azelate, dioctyl azelate, glycerol, trimethylolpropane, pentaerythritol, sorbitol, glycerin triacetate (triacetin), diglycerin tetracetate, triethyl phosphate, tributyl phosphate, tributoxyethyl phosphate, triphenyl phosphate, and tricresyl phosphate, and combinations thereof. In one embodiment or in any of the mentioned embodiments, the cellulose acetate fibers may not include any type of plasticizer or other additive, and can consist essentially of, or consist of, cellulose acetate and not more than 1 percent FOY of a spinning finish.

Additionally, the cellulose acetate fibers may not have undergone additional treatment steps designed to enhance the biodegradability of the fibers. For example, the fibers may not have been hydroylzed or treated with enzymes or microorganisms. The fibers may include not more than 1, 0.75, 0.5, 0.25, 0.1, 0.05, or 0.01 weight percent of an adhesive or bonding agent and may include less than 1, 0.75, 0.5, 0.25, 0.1, 0.05, or 0.01 weigh percent of modified or substituted cellulose acetate. In one embodiment or in any of the mentioned embodiments, the fibers may not include any adhesive or bonding agent and may not be formed from any substituted or modified cellulose acetate. Substituted or modified cellulose acetate may include cellulose acetate that has been modified with a polar substituent, such as a substituent selected from the group consisting of sulfates, phosphates, borates, carbonates, and combinations thereof.

The cellulose acetate fibers can achieve higher levels of biodegradability and/or compostability without using additives that have traditionally been used to facilitate environmental non-persistence of similar fibers. Such additives can include, for example, photodegradation agents, biodegradation agents, decomposition accelerating agents, and/or various types of other additives. In one embodiment or in any of the mentioned embodiments, despite being substantially free of these types of additives, the cellulose acetate fibers and articles produced therefrom can unexpectedly exhibit enhanced biodegradability and compostability when tested under industrial, home, and/or soil conditions.

It should be noted that, unlike silk fibers, the cellulose acetate fibers described herein are sustainable because they are derived from a cellulosic backbone obtained from plants, such as wood or cotton. Unlike silk fibers, cellulose acetate is a fiber that can be tailored more readily synthetically to desired specifications and properties that can be imparted to improve fiber blend properties.

In one embodiment or in any of the mentioned embodiments, the cellulose acetate fibers may be substantially free of photodegradation agents. For example, the cellulose acetate fibers may include not more than 1, 0.75, 0.50, 0.25, 0.10, 0.05, 0.025, 0.01, 0.005, 0.0025, or 0.001 weight percent of at least one photodegradation agent, based on the total weight of the fiber, or the fibers may include no photodegradation agents. Examples of such photodegradation agents include, but are not limited to, pigments which act as photooxidation catalysts and are optionally augmented by the presence of one or more metal salts, oxidizable promoters, and combinations thereof. Pigments can include coated or uncoated anatase or rutile titanium dioxide, which may be present alone or in combination with one or more of the augmenting components such as, for example, various types of metals. Other examples of photodegradation agents include benzoins, benzoin alkyl ethers, benzophenone and its derivatives, acetophenone and its derivatives, quinones, thioxanthones, phthalocyanine and other photosensitizers, ethylene-carbon monoxide copolymer, aromatic ketone-metal salt sensitizers, and combinations thereof.

In one embodiment or in any of the mentioned embodiments, the cellulose acetate fibers may be substantially free of biodegradation agents and/or decomposition agents. For example, the cellulose acetate fibers may include not more than 1, 0.75, 0.50, 0.25, 0.10, 0.05, 0.025, 0.01, 0.005, 0.0025, 0.0020, 0.0015, 0.001, 0.0005 weight percent of biodegradation agents and/or decomposition agents, based on the total weight of the fiber, or the fibers may include no biodegradation and/or decomposition agents. Examples of such biodegradation and decomposition agents include, but are not limited to, salts of oxygen acid of phosphorus, esters of oxygen acid of phosphorus or salts thereof, carbonic acids or salts thereof, oxygen acids of phosphorus, oxygen acids of sulfur, oxygen acids of nitrogen, partial esters or hydrogen salts of these oxygen acids, carbonic acid and its hydrogen salt, sulfonic acids, and carboxylic acids.

Other examples of such biodegradation and decomposition agents include an organic acid selected from the group consisting of oxo acids having 2 to 6 carbon atoms per molecule, saturated dicarboxylic acids having 2 to 6 carbon atoms per molecule, and lower alkyl esters of the oxo acids or the saturated dicarboxylic acids with alcohols having from 1 to 4 carbon atoms. Biodegradation agents may also comprise enzymes such as, for example, a lipase, a cellulase, an esterase, and combinations thereof. Other types of biodegradation and decomposition agents can include cellulose phosphate, starch phosphate, calcium secondary phosphate, calcium tertiary phosphate, calcium phosphate hydroxide, glycolic acid, lactic acid, citric acid, tartaric acid, malic acid, oxalic acid, malonic acid, succinic acid, succinic anhydride, glutaric acid, acetic acid, and combinations thereof.

The cellulose acetate fibers may also be substantially free of several other types of additives that have been added to other fibers to encourage environmental non-persistence. Examples of these additives can include, but are not limited to, polyesters, including aliphatic and low molecular weight (e.g., less than 5000) polyesters, enzymes, microorganisms, water soluble polymers, modified cellulose acetate, water-dispersible additives, nitrogen-containing compounds, hydroxy-functional compounds, oxygen-containing heterocyclic compounds, sulfur-containing heterocyclic compounds, anhydrides, monoepoxides, and combinations thereof. In one embodiment or in any of the mentioned embodiments, the cellulose acetate fibers may include not more than 0.5, 0.4, 0.3, 0.25, 0.1, 0.075, 0.05, 0.025, 0.01, 0.0075, 0.005, 0.0025, or 0.001 weight percent of these types of additives, or the cellulose acetate fibers may not include any of these types of additives.

The cellulose acetate staple fibers and nonwovens formed therefrom can be biodegradable, meaning that such fibers are expected to decompose under certain environmental conditions. The degree of degradation can be characterized by the weight loss of a sample over a given period of exposure to certain environmental conditions. In one embodiment or in any of the mentioned embodiments, the material used to form the staple fibers, the nonwoven webs, or articles produced from the fibers can exhibit a weight loss of at least 5, 10, 15, or 20 percent after burial in soil for 60 days and/or a weight loss of at least 15, 20, 25, 30, or 35 percent after 15 days of exposure to a typical municipal composter. However, the rate of degradation may vary depending on the particular end use of the fibers, as well as the composition of the remaining article, and the specific test. Exemplary test conditions are provided in U.S. Pat. Nos. 5,970,988 and 6,571,802.

In one embodiment or in any of the mentioned embodiments, the cellulose acetate fibers may be biodegradable and such fibers may be used to form nonwoven webs (as discussed below). Unexpectedly, it has been found that the cellulose acetate fibers can exhibit enhanced levels of environmental non-persistence, characterized by better-than-expected degradation under various environmental conditions. The fibers and fibrous articles described herein may meet or exceed passing standards set by international test methods and authorities for industrial compostability, home compostability, and/or soil biodegradability.

To be considered “compostable,” a material must meet the following four criteria: (1) the material must be biodegradable; (2) the material must be disintegrable; (3) the material must not contain more than a maximum amount of heavy metals; and (4) the material must not be ecotoxic. As used herein, the term “biodegradable” generally refers to the tendency of a material to chemically decompose under certain environmental conditions. Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

The cellulose acetate fibers can exhibit a biodegradation of at least 70 percent in a period of not more than 50 days, when tested under aerobic composting conditions at ambient temperature (28° C.±2° C.) according to ISO 14855-1 (2012). In one embodiment or in any of the mentioned embodiments, the cellulose acetate fibers can exhibit a biodegradation of at least 70 percent in a period of not more than 49, 48, 47, 46, 45, 44, 43, 42, 41, 40, 39, 38, or 37 days when tested under these conditions, also called “home composting conditions.” These conditions may not be aqueous or anaerobic. In some other cases, the cellulose acetate fibers can exhibit a total biodegradation of at least 71, 72, 73, 74, 75, 76, 77, 78, 79, 80, 81, 82, 83, 84, 85, 86, 87, or 88 percent, when tested under according to ISO 14855-1 (2012) for a period of 50 days under home composting conditions. This may represent a relative biodegradation of at least 95, 97, 99, 100, 101, 102, or 103 percent, when compared to cellulose subjected to identical test conditions.

To be considered “biodegradable,” under home composting conditions according to the French norm NF T 51-800 and the Australian standard AS 5810, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradation under home compositing conditions is 1 year. The cellulose acetate staple fibers may exhibit a biodegradation of at least 90 percent within not more than 1 year, measured according 14855-1 (2012) under home composting conditions. In one embodiment or in any of the mentioned embodiments, the cellulose acetate staple fibers may exhibit a biodegradation of at least 91, 92, 93, 94, 95, 96, 97, 98, 99, or 99.5 percent within not more than 1 year, or the fibers may exhibit 100 percent biodegradation within not more than 1 year, measured according 14855-1 (2012) under home composting conditions.

Additionally, or in the alternative, the cellulose acetate staples fibers may exhibit a biodegradation of at least 90 percent within not more than 350, 325, 300, 275, 250, 225, 220, 210, 200, 190, 180, 170, 160, 150, 140, 130, 120, 110, 100, 90, 80, 70, 60, or 50 days, measured according 14855-1 (2012) under home composting conditions. In one embodiment or in any of the mentioned embodiments, the fibers can be at least 97, 98, 99, or 99.5 percent biodegradable within not more than 70, 65, 60, or 50 days of testing according to ISO 14855-1 (2012) under home composting conditions. As a result, the CA fibers may be considered biodegradable according to, for example, French Standard NF T 51-800 and Australian Standard AS 5810 when tested under home composting conditions.

The cellulose acetate staple fibers can exhibit a biodegradation of at least 60 percent in a period of not more than 45 days, when tested under aerobic composting conditions at a temperature of 58° C. (±2° C.) according to ISO 14855-1 (2012). In one embodiment or in any of the mentioned embodiments, the fibers can exhibit a biodegradation of at least 60 percent in a period of not more than 44, 43, 42, 41, 40, 39, 38, 37, 36, 35, 34, 33, 32, 31, 30, 29, 28, or 27 days when tested under these conditions, also called “industrial composting conditions.” These may not be aqueous or anaerobic conditions. In one embodiment or in any of the mentioned embodiments, the cellulose acetate fibers can exhibit a total biodegradation of at least 65, 70, 75, 80, 85, 87, 88, 89, 90, 91, 92, 93, 94, or 95 percent, when tested under according to ISO 14855-1 (2012) for a period of 45 days under industrial composting conditions. This may represent a relative biodegradation of at least 95, 97, 99, 100, 102, 105, 107, 110, 112, 115, 117, or 119 percent, when compared to cellulose fibers subjected to identical test conditions.

To be considered “biodegradable,” under industrial composting conditions according to ASTM D6400 and ISO 17088, at least 90 percent of the organic carbon in the whole item (or for each constituent present in an amount of more than 1% by dry mass) must be converted to carbon dioxide by the end of the test period when compared to the control or in absolute. According to European standard ED 13432 (2000), a material must exhibit a biodegradation of at least 90 percent in total, or a biodegradation of at least 90 percent of the maximum degradation of a suitable reference material after a plateau has been reached for both the reference and test item. The maximum test duration for biodegradability under industrial compositing conditions is 180 days. The cellulose acetate fibers described herein may exhibit a biodegradation of at least 90 percent within not more than 180 days, measured according 14855-1 (2012) under industrial composting conditions. In one embodiment or in any of the mentioned embodiments, the cellulose acetate fibers may exhibit a biodegradation of at least 91, 92, 93, 94, 95, 96, 97, 98, 99, or 99.5 percent within not more than 180 days, or the fibers may exhibit 100 percent biodegradation within not more than 180 days, measured according 14855-1 (2012) under industrial composting conditions.

Additionally, or in the alternative, the cellulose acetate fibers may exhibit a biodegradation of least 90 percent within not more than 175, 170, 165, 160, 155, 150, 145, 140, 135, 130, 125, 120, 115, 110, 105, 100, 95, 90, 85, 80, 75, 70, 65, 60, 55, 50, or 45 days, measured according 14855-1 (2012) under industrial composting conditions. In one embodiment or in any of the mentioned embodiments, the cellulose acetate fibers can be at least 97, 98, 99, or 99.5 percent biodegradable within not more than 65, 60, 55, 50, or 45 days of testing according to ISO 14855-1 (2012) under industrial composting conditions. As a result, the cellulose acetate fibers may be considered biodegradable according to ASTM D6400 and ISO 17088 when tested under industrial composting conditions.

The fibers or fibrous articles may exhibit a biodegradation in soil of at least 60 percent within not more than 130 days, measured according to ISO 17556 (2012) under aerobic conditions at ambient temperature. In one embodiment or in any of the mentioned embodiments, the fibers can exhibit a biodegradation of at least 60 percent in a period of not more than 130, 120, 110, 100, 90, 80, or 75 days when tested under these conditions, also called “soil composting conditions.” These may not be aqueous or anaerobic conditions.

In one embodiment or in any of the mentioned embodiments, the fibers can exhibit a total biodegradation of at least 65, 70, 72, 75, 77, 80, 82, or 85 percent, when tested under according to ISO 17556 (2012) for a period of 195 days under soil composting conditions. This may represent a relative biodegradation of at least 70, 75, 80, 85, 90, or 95 percent, when compared to cellulose fibers subjected to identical test conditions.

In order to be considered “biodegradable,” under soil composting conditions according the OK biodegradable SOIL conformity mark of Vinçotte and the DIN Geprüft Biodegradable in soil certification scheme of DIN CERTCO, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradability under soil compositing conditions is 2 years. The cellulose acetate fibers may exhibit a biodegradation of at least 90 percent within not more than 2 years, 1.75 years, 1 year, 9 months, or 6 months measured according to ISO 17556 (2012) under soil composting conditions. In one embodiment or in any of the mentioned embodiments, the cellulose acetate fibers may exhibit a biodegradation of at least 91, 92, 93, 94, 95, 96, 97, 98, 99, or 99.5 percent within not more than 2 years, or the fibers may exhibit 100 percent biodegradation within not more than 2 years, measured according to ISO 17556 (2012) under soil composting conditions.

Additionally, or in the alternative, the cellulose acetate fibers may exhibit a biodegradation of at least 90 percent within not more than 700, 650, 600, 550, 500, 450, 400, 350, 300, 275, 250, 240, 230, 220, 210, 200, or 195 days, measured according 17556 (2012) under soil composting conditions. In one embodiment or in any of the mentioned embodiments, the cellulose acetate fibers can be at least 97, 98, 99, or 99.5 percent biodegradable within not more than 225, 220, 215, 210, 205, 200, or 195 days of testing according to ISO 17556 (2012) under soil composting conditions. As a result, the cellulose acetate fibers may meet the requirements to receive the OK biodegradable SOIL conformity mark of Vinçotte and to meet the standards of the DIN Geprüft Biodegradable in soil certification scheme of DIN CERTCO.

In one embodiment or in any of the mentioned embodiments, the cellulose acetate fibers or fibrous articles produced therefrom of the present disclosure may include less than 1, 0.75, 0.50, or 0.25 weight percent of components of unknown biodegradability. In one embodiment or in any of the mentioned embodiments, the fibers or fibrous articles described herein may include no components of unknown biodegradability.

In addition to being biodegradable under industrial and/or home composting conditions, the cellulose acetate fibers or fibrous articles as described herein may also be compostable under home and/or industrial conditions. As described previously, a material is considered compostable if it meets or exceeds the requirements set forth in EN 13432 for biodegradability, ability to disintegrate, heavy metal content, and ecotoxicity. The cellulose acetate fibers or fibrous articles produced therefrom may exhibit sufficient compostability under home and/or industrial composting conditions to meet the requirements to receive the OK compost and OK compost HOME conformity marks from Vinçotte.

In one embodiment or in any of the mentioned embodiments, the cellulose acetate fibers or fibrous articles produced therefrom can exhibit a disintegration of at least 90 percent within not more than 26 weeks, measured according to ISO 16929 (2013) under industrial composting conditions. In one embodiment or in any of the mentioned embodiments, the fibers or fibrous articles may exhibit a disintegration of at least 91, 92, 93, 94, 95, 96, 97, 98, 99, or 99.5 percent under industrial composting conditions within not more than 26 weeks, or the fibers or articles may be 100 percent disintegrated under industrial composting conditions within not more than 26 weeks. Alternatively, or in addition, the fibers or articles may exhibit a disintegration of at least 90 percent under industrial compositing conditions within not more than 26, 25, 24, 23, 22, 21, 20, 19, 18, 17, 16, 15, 14, 13, 12, 11, or 10 weeks, measured according to ISO 16929 (2013). In one embodiment or in any of the mentioned embodiments, the cellulose acetate fibers or fibrous articles produced therefrom may be at least 97, 98, 99, or 99.5 percent disintegrated within not more than 12, 11, 10, 9, or 8 weeks under industrial composting conditions, measured according to ISO 16929 (2013).

In one embodiment or in any of the mentioned embodiments, the cellulose acetate fibers or fibrous articles produced therefrom can exhibit a disintegration of at least 90 percent within not more than 26 weeks, measured according to ISO 16929 (2013) under home composting conditions. In one embodiment or in any of the mentioned embodiments, the fibers or fibrous articles may exhibit a disintegration of at least 91, 92, 93, 94, 95, 96, 97, 98, 99, or 99.5 percent under home composting conditions within not more than 26 weeks, or the fibers or articles may be 100 percent disintegrated under home composting conditions within not more than 26 weeks. Alternatively, or in addition, the fibers or articles may exhibit a disintegration of at least 90 percent within not more than 26, 25, 24, 23, 22, 21, 20, 19, 18, 17, 16, or 15 weeks under home composting conditions, measured according to ISO 16929 (2013). In one embodiment or in any of the mentioned embodiments, the cellulose acetate fibers or fibrous articles may be at least 97, 98, 99, or 99.5 percent disintegrated within not more than 20, 19, 18, 17, 16, 15, 14, 13, or 12 weeks, measured under home composting conditions according to ISO 16929 (2013).

### Fiber Blends and Fill Materials

The cellulose acetate staple fibers described herein may be used to produce various fiber blends and/or articles, such as fill materials for textiles, which can include the aforementioned fiber blends or be produced entirely from the cellulose acetate fibers. In one embodiment or in any of the mentioned embodiments, the articles and/or fill materials described herein can comprise, consist essentially of, or consist of the cellulose acetate staple fibers.

As noted above, it has been discovered that the long cut cellulose acetate staple fibers described herein can be used to at least partially replace, or completely replace, silk fibers in fiber blends and/or fill materials.

Generally, fiber blends containing the cellulose acetate staple fibers can comprise at least 25, 30, 35, 40, 45, 50, 55, 60, 65, 70, 75, 80, 85, 90, 95, or 99 weight percent of the staple fiber based on the total weight of the fiber blend. Additionally, or in the alternative, the fiber blend can comprise not more than 99, 95, 90, 95, 90, 85, 80, 75, 70, 65, 60, 55, or 50 weight percent of the staple fiber based on the total weight of the fiber blend.

Likewise, articles, such as the fill materials, containing the cellulose acetate staple fibers can comprise at least 25, 30, 35, 40, 45, 50, 55, 60, 65, 70, 75, 80, 85, 90, 95, or 99 weight percent of the staple fiber based on the total weight of the fill material. Additionally, or in the alternative, the articles (such as the fill materials) can comprise not more than 99, 95, 90, 95, 90, 85, 80, 75, 70, 65, 60, 55, or 50 weight percent of the staple fiber based on the total weight of the fill material. In certain embodiments, the articles (such as the fill materials) can be produced entirely with the cellulose acetate staple fibers (i.e., 100 weight percent of cellulose acetate staple fibers).

The fiber blends and/or fill materials described herein can comprise other optional fibers and/or additives in addition to the cellulose acetate staple fibers described herein. For instance, and as described below in greater detail, the fiber blends and/or fill materials may optionally comprise at least one secondary fiber, at least one additional cellulose acetate staple fiber, at least one bonding agent (e.g., an adhesive), or a combination thereof. In certain embodiments, the fiber blends and/or fill materials may comprise at least 1, 2, 5, 10, 15, 20, 25, 30, 35, 40, 45, or 50 weight percent of at least one secondary fiber, at least one additional cellulose acetate staple fiber, at least one bonding agent, or a combination thereof, based on the total weight of the blend or material. Additionally, or in the alternative, the fiber blends and/or fill materials may comprise not more than 90, 80, 70, 60, 50, 40, 30, 25, 20, 15, 10, 5, 4, 3, 2, 1, 0.5, or 0.1 weight percent of at least one secondary fiber, at least one additional cellulose acetate staple fiber, at least one bonding agent, or a combination thereof, based on the total weight of the blend or material.

In one embodiment or in any of the mentioned embodiments, the fiber blends and/or fill materials may comprise a secondary fiber, such as a silk fiber, cotton fiber, flax fiber, rayon fiber, an acrylic fiber, a polyester fiber, a polyamide fiber, a polyolefin fiber, a recycled fiber, a non-recycled (virgin) fiber, a compostable fiber, a biodegradable fiber, a staple (i.e., cut) fiber, a wool fiber, cellulosic fiber, a hemp fiber, a plant-based fiber, an animal-based fiber, a plant-based fiber, a mineral-based fiber, a synthetic-based fiber, or a combination thereof. In certain embodiments, the fiber blends and/or fill materials may comprise at least 1, 2, 5, 10, 15, 20, 25, 30, 35, 40, 45, or 50 weight percent of one or more secondary fibers, such as silk fibers, based on the total weight of the blend or material. Additionally, or in the alternative, the fiber blends and/or fill materials may comprise not more than 90, 80, 70, 60, 50, 40, 30, 25, 20, 15, 10, 5, 4, 3, 2, 1, 0.5, or 0.1 weight percent of one or more secondary fibers, such as silk fibers, based on the total weight of the blend or material.

In one embodiment or in any of the mentioned embodiments, the fiber blends and/or fill materials may comprise a silk fiber. In certain embodiments, the fiber blends and/or fill materials may comprise at least 1, 2, 5, 10, 15, 20, 25, 30, 35, 40, 45, or 50 weight percent of silk fibers, based on the total weight of the blend or material. Additionally, or in the alternative, the fiber blends and/or fill materials may comprise not more than 90, 80, 70, 60, 50, 40, 30, 25, 20, 15, 10, 5, 4, 3, 2, 1, 0.5, or 0.1 weight percent of silk fibers, based on the total weight of the blend or material. The silk fiber can include any variety of silk fiber, such as, for example, tasar, muga, and/or eri.

It is desirable that the physical parameters (e.g., DPF and/or cut length) of the secondary fibers be compatible with the cellulose acetate staple fibers so that they can be distributed throughout the blend by conventional textile processing. The secondary fibers may have a cut length and/or DPF within any of the ranges expressed above in regard to the cellulose acetate staple fibers. In certain embodiments, the secondary fibers may have a cut length and/or DPF that is substantially similar to the cellulose acetate staple fibers. For example, the secondary fibers have a cut length and/or DPF that is within ±30 percent, ±20 percent, or ±10 percent of the cut length and/or DPF of the cellulose acetate staple fibers. The fibers may also have a distribution of cut lengths.

In embodiments wherein the fiber blend comprises at least one silk fiber, the cellulose acetate staple fiber can have a cut length of at least 96 mm, at least 150 mm, at least 175 mm, or at least 200 mm and/or not more than 300 mm. It has been discovered that the longer cut lengths allow the cellulose acetate staple fibers to be more readily blended with the silk fibers.

In one embodiment or in any of the mentioned embodiments, the fiber blend and/or fill materials may contain at least two different cellulose acetate staple fibers with two or more different DPFs and/or cut lengths. For example, one set of the cellulose acetate staple fibers may have a cut length of 150 mm and a second set of cellulose acetate staple fibers may have a cut length of 95 mm. In one or more embodiments, the fiber blends and/or fill materials may comprise at least 1, 2, 5, 10, 15, 20, 25, 30, 35, 40, 45, or 50 weight percent of at least one additional cellulose acetate staple fiber, based on the total weight of the blend or material. Additionally, or in the alternative, the fiber blends and/or fill materials may comprise not more than 90, 80, 70, 60, 50, 40, 30, 25, 20, 15, 10, 5, 4, 3, 2, 1, 0.5, or 0.1 weight percent of at least one additional cellulose acetate staple fiber, based on the total weight of the blend or material. These additional cellulose acetate staple fibers may have a cut length and/or DPF within any of the ranges expressed above regarding the cellulose acetate staple fibers. In certain embodiments, the cellulose acetate staple fibers can both be made of the same cellulose acetate type (e.g., cellulose diacetate) or can be formed of different cellulose acetate types (e.g., one fiber may be made from cellulose triacetate and the other fiber may be made from cellulose diacetate).

In one embodiment or in any of the mentioned embodiments, the fiber blend and/or fill materials may contain at least one binder fiber. In one or more embodiments, the fiber blends and/or fill materials may comprise at least 1, 2, 5, 10, 15, 20, or 25 weight percent of at least one binder fiber, based on the total weight of the blend or material. Additionally, or in the alternative, the fiber blends and/or fill materials may comprise not more than 50, 40, 30, 25, 20, 15, 10, 5, 4, 3, 2, 1, 0.5, or 0.1 weight percent of at least one binder fiber, based on the total weight of the blend or material. These additional binder fibers may have a cut length and/or DPF within any of the ranges expressed above regarding the cellulose acetate staple fibers.

There is no particular restriction on the type of binder fiber that can be used in the fiber blend or fill material, provided that the binder fiber (or at least a portion of it) has a lower melting point than that of the cellulose acetate staple fiber. The binder fiber can be processed on conventional textile machinery, e.g., a card, and be distributed throughout the blend. It is desirable, therefore, that the DPF of the binder fiber be compatible with the denier of the cellulose acetate staple fibers so that it can be distributed throughout the blend by conventional textile processing. Ideally, it could be preferable to use a binder fiber of substantially the same denier as that of the CA staple fiber, but a satisfactory result can be obtained by using binder fiber having a higher or a low denier.

Generally, binder fibers may be made of, but not limited to, polyesters, such as polyethylene terephthalate (PET); copolymers thereof; polyolefins, such as polypropylene and polyethylene; and mixtures thereof. In one embodiment or in any of the mentioned embodiments, the binder fibers may be single-component fibers, while, in other cases, the fibers could be multicomponent fibers. When the binder fibers are bicomponent or multicomponent fibers, they may have any suitable cross-section, including, for example, in a side-by-side cross-section, a core-and-sheath cross-section, an islands-in-the-sea cross-section, a tipped cross-section, or a segmented pie cross-section. In certain cases, the binder fiber can be a bicomponent fiber comprising a polyester (e.g., PET) and a copolyester (e.g., PETG). In other cases, the binder fiber can be a bicomponent fiber comprising a polyester (e.g., PET) and a polyolefin (e.g., PE or PP). in yet other cases, the binder fiber can be a bicomponent fiber comprising a first polyolefin (e.g., PE) and a second polyolefin (e.g., PP).

Specific examples of binder fibers are described in U.S. Pat. Nos. 4,068,036; 4,129,675; and 4,304,817, the disclosures of these references are incorporated herein by reference.

The fiber blend and the fill materials of the present disclosure may be prepared by conventional blending techniques. The fiber blend or the cellulose acetate staple fibers (if used alone) may then undergo a web forming step and a web bonding step to form a thermally-bonded, nonwoven web. The web forming step may be performed under dry conditions, and the web bonding step may be carried out thermally. The web forming step may include one or more dry-laid processes. Dry-laid processes include air-laying and carding processes.

In an air-laid process, the fibers are entrained in streams of air, which are directed to a conveyor, onto which the fibers are deposited to form a web. In a carding process, fibers placed on a conveyor, or card, and are passed through a pair of rollers (or other movable surfaces) having a set of metal teeth or other gripping surfaces. As the surfaces move relative to one another, the fibers are mechanically separated and aligned to form a web.

In one embodiment or in any of the mentioned embodiments, the cellulose acetate staple fibers are lapped horizontally relative to the web's thickness. In other cases, after the dry-laying process, the web may be passed to a vertical lapping machine to impose a plurality of vertical parallel pleats on the web, relative to the web's thickness, which are then compressed to form a pleated web. The pleated web may be joined face-to-face with a second adhesive web to create a laminated composite web. Examples of vertical lapping machines are described in U.S. Pat. Nos. 5,995,174; 7,591,049; and 9,783,915.

Once the web is formed, the web may be transported to a web bonding zone where it is heated to form a bonded web. Examples of thermal bonding methods include, but are not limited to, calendaring, ultrasonic bonding, and through-air oven bonding. Particular suitable combinations of web formation and bonding steps include, but are not limited to, formation by carding and thermal bonding or air-laying and thermal bonding.

The process for forming a nonwoven web with cellulose acetate staple fibers as described herein may be performed on a lab-, pilot-, and/or commercial scale. It has been discovered that use of the cellulose acetate fibers described herein may provide processing advantages that permit formation of nonwoven webs on a larger, commercial scale. For example, in one embodiment or in any of the mentioned embodiments, the web forming step may be carried out at a rate of at least 50, 75, 100, 125, 150, 175, 200, 225, 250, 275, 300, 325, 350, 375, 400, 425, 450, 475, or 500 meters per minute (m/min). Additionally, or in the alternative, the web forming step may be performed at a rate of not more than 600, 575, 550, 525, 500, 475, 450, 425, 400, 375, 350, 325, or 300 m/min.

In one embodiment or in any of the mentioned embodiments, the nonwoven web and/or the articles produced herein of the present disclosure can have a thickness of at least 0.25, 0.30, 0.35, 0.40, 0.45, 0.50, 0.55, 0.60, 0.65, 0.70, 0.75, 0.80, 0.85, 0.90, or 0.95 mm and/or not more than 2.75, 2.5, 2.25, 2.0, 1.9, 1.8, 1.7, 1.6, 1.5, 1.4, 1.3, 1.2, 1.1, 1.05, 0.95, 0.90, 0.85, 0.80, 0.75, 0.70, 0.65, 0.60, 0.55, or 0.50 mm. In one embodiment or in any of the mentioned embodiments, the thickness of the nonwoven web and/or the articles produced herein can be at least 20, 30, 40, 50, 60, 70, 80, 90, 100, 125, 150, 175, or 200 mm and/or not more than 400, 375, 350, 325, 300, 275, 250, 225, 200, 175, 150, 125, 100, 90, 80, 70, 60, 50, 40, 30, or 20 mm. Thickness can be measured according to NWSP 120.1.R0 (15).

The nonwoven web and/or the articles produced herein can have a basis weight of at least 15, 20, 25, 30, 35, 40, 45, 50, 51, 52, 53, 54, 55, 56, 57, 58, 59, 60, 61, or 62 grams per square meter (gsm) and/or not more than 80, 75, 74, 73, 72, 71, 70, 69, 68, 67, 66, 65, 64, 63, or 62 gsm. In one embodiment or in any of the mentioned embodiments, the nonwoven web and/or the articles produced herein can have a basis weight of at least 50, 75, 100, 125, 150, 175, 200, 225, 250, 275, 300, 325, 350, 375, 400, 425, 450, 475, 500, 525, 550, 575, 600, 700, 800, 900, or 1000 gsm. Alternatively, or in addition, the nonwoven web and/or the articles produced herein may have a basis weight of not more than 8000, 7500, 7000, 6500, 6000, 5500, 5000, 4500, 4000, 3500, 3000, 2500, 2000, 1500, 1000, 500, 400, 300, 200, or 150 gsm. Basis weight can be measured according to NWSP 130.1.R0 (15).

According to some embodiments, the nonwoven web and/or the articles produced herein can exhibit one or more of the following characteristics: (i) a wet tensile strength in the machine direction (MD) in the range of 10 to 2000 Nm²/kg, normalized for the basis weight of the nonwoven; (ii) a wet tensile strength in the cross direction (CD) in the range of 10 to 1000 Nm²/kg, normalized for the basis weight of the nonwoven; (iii) a dry tensile strength in the machine direction (MD) in the range of 10 to 2000 Nm²/kg, normalized for the basis weight of the nonwoven; (iv) a dry tensile strength in the cross direction (CD) in the range of 10 to 1000 Nm²/kg, normalized for the basis weight of the nonwoven; an absorbency in the range of 5 to 20 grams of water per grams of fiber (g/g); and (vi) a real softness in the range of from 2.5 to 6 dB. In one embodiment or in any of the mentioned embodiments, the nonwoven may exhibit at least two, at least three, at least four, at least five, or all of characteristics (i) through (vi) listed above.

In one embodiment or in any of the mentioned embodiments, the nonwoven web and/or the articles produced herein can have a dry tensile strength in the machine direction of at least 0.5, 1, 2, 5, 10, 12, 15, 20, 25, 30, 35, 40, 45, 50, 55, or 60 N/in and/or not more than 250, 245, 240, 235, 230, 225, 220, 215, 210, 205, 200, 195, 190, 185, 180, 175, 170, 165, 160, 155, 150, 145, 140, 135, 130, 125, 120, 115, 110, 100, 95, 90, 85, 90, 75, 60, 5, 50, 45, 40, 35, 30, or 25 N/in, measured according to the procedure described in NWSP 110.4 Option A with a 1-inch test strip. All tensile strength measurements were performed on a 1-inch strip of sample, unless otherwise stated.

Additionally, or in the alternative, the nonwoven web and/or the articles produced herein may have a dry tensile strength in the cross direction of at least 0.5, 1, 3, 4, 5, 10, 15, 20, 25, 30, 35, 40, or 45 N/in and/or not more than 225, 200, 190, 180, 175, 170, 160, 150, 140, 130, 125, 120, 110, 100, 90, 80, 75, 70, 60, 50, 45, 40, 35, 30, 25, 20, 15, 12, 10, 8, or 5 N/in, measured according to NWSP 110.4 Option A.

In one embodiment or in any of the mentioned embodiments, the ratio of dry tensile strength in the machine direction to dry tensile strength in the cross direction (dry MD:CD) can be no more than 10:1, 9.5:1, 9:1, 8.5:1, 8:1, 7.5:1, 7:1, 6.5:1, 6:1, 5.5:1, 5:1, 4.5:1, 4:1, 3.5:1, 3:1, 2.5:1, 2:1, 1.5:1, 1.25:1, or 1.1:1. In one embodiment or in any of the mentioned embodiments, the ratio of dry MD:CD can be at least 1.01:1, 1.05:1, 1.10:1, 1.15:1, 1.20:1, 1.25:1, 1.30:1, 1.35:1, 1.4:1, 1.45:1, 1.5:1, 1.55:1, 1.6:1, 1.65:1, 1.7:1, 1.75:1, 1.8:1, or 1.85:1.

The nonwoven web and/or the articles produced herein may have a wet tensile strength in the machine direction of at least 0.5, 1, 1.5, 5, 10, 15, 20, 25, 30, 35, 40, 45, or 50 N and/or not more than 250, 240, 230, 220, 210, 200, 190, 180, 170, 160, 150, 145, 140, 135, 130, 125, 120, 115, 110, 105, 100, 95, 90, 85, 80, 75, 70, 65, 60, 50, 40, 35, 30, 25, or 20 N/in, measured according to NWSP 110.4 Option A.

Additionally, the nonwoven web and/or the articles produced herein can have a wet tensile strength in the cross-direction of at least 0.5, 1, 1.5, 2, 3, 4, 5, 8, 10, 12, 15, 18, or 20 N/in and/or not more than 120, 115, 110, 105, 100, 95, 90, 85, 80, 75, 70, 65, 60, 55, 50, 45, 40, 35, 30, 28, 25, 20, 15, 12, or 10 N/in, measured according to NWSP 110.4 Option A.

In one embodiment or in any of the mentioned embodiments, the ratio of wet tensile strength in the machine direction to wet tensile strength in the cross direction (wet MD:CD) can be no more than 10:1, 9.5:1, 9:1, 8.5:1, 8:1, 7.5:1, 7:1, 6.5:1, 6:1, 5.5:1, 5:1, 4.5:1, 4:1, 3.5:1, 3:1, 2.5:1, 2:1, 1.5:1, 1.25:1, or 1.1:1. In one embodiment or in any of the mentioned embodiments, the ratio of wet MD: CD can be at least 1.01:1, 1.05:1, 1.10:1, 1.15:1, 1.20:1, 1.25:1, 1.30:1, 1.35:1, 1.4:1, 1.45:1, 1.5:1, 1.55:1, 1.6:1, 1.65:1, 1.7:1, 1.75:1, 1.8:1, or 1.85:1.

The tensile strength of the nonwoven web and/or the articles produced herein may be normalized according to the basis weight, thickness, and/or bulk density of the web. In one embodiment or in any of the mentioned embodiments, the nonwoven web and/or the articles produced herein may have a wet tensile strength in the machine direction, normalized for the basis weight of the nonwoven, of at least 10, 20, 40, 60, 80, 100, 200, 300, 400, 500, 600, 700, 800, or 900 Nm²/kg and/or not more than 2000, 1900, 1800, 1700, 1600, 1500, 1400, 1300, 1200, 1100, 1000, 900, 800, 700, 600, 500, or 400 Nm²/kg, measured according to NWSP 110.4 Option A. Additionally, the nonwoven web and/or the articles produced herein may have a wet tensile strength in the cross-direction, normalized for the basis weight of the nonwoven, of at least 10, 20, 40, 60, 80, 100, 200, 240, or 250 Nm²/kg and/or not more than 1000, 900, 800, 700, 600, 560, 500, 400, or 300 Nm²/kg, measured according to NWSP 110.4 Option A.

The dry tensile strength in the machine direction, normalized according to basis weight of the nonwoven, may be at least 10, 25, 50, 100, 200, 300, 400, 500, 600, 700, 800, 900, or 1000 Nm²/kg and/or not more than 5000, 4500, 4000, 3500, 3400, 3000, 2500, 2000, 1500, 1000, 750, or 500 Nm²/kg, while the dry tensile strength in the cross direction normalized for basis weight can be at least 10, 25, 50, 80, 100, 200, 250, or 300 Nm²/kg and/or not more than 4000, 3500, 3000, 2500, 2000, 1500, 1200, 1000, 900, or 500 Nm²/kg, measured according to NWSP 100.4 Option A.

The nonwoven web and/or the articles produced herein may have a wet tensile strength in the machine direction, normalized for the thickness of the nonwoven, of at least 2000, 3000, 4000, 5000, 6000, 7000, 8000, 9000, 10,000, 15,000, 20,000, 25,000, 30,000, 35,000, 40,000, or 45,000 N/m and/or not more than 150,000, 145,000, 140,000, 135,000, 130,000, 125,000, 120,000, 117,000, 115,000, 110,000, 100,000, 80,000, 60,000, 40,000, or 20,000 N/m, measured according to NWSP 110.4 Option A. Additionally, the nonwoven web and/or the articles produced herein may have a wet tensile strength in the cross-direction, normalized for the thickness of the nonwoven, of at least 2000, 3000, 4000, 5000, 6000, 7000, 8000, 9000, 10,000, 12,000, 15,000, or 20,000 N/m and/or not more than 100,000, 95,000, 90,000, 85,000, 83,000, 80,000, 75,000, 70,000, 65,000, 60,000, 55,000, 50,000, 47,000, 45,000, or 40,000 N/m, measured according to NWSP 110.4 Option A.

The dry tensile strength in the machine direction, normalized according to the thickness of the nonwoven, may be at least 1000, 2000, 3000, 4000, 5000, 6000, 7000, 8000, 9000, 10,000, 12,000, 15,000, 20,000, 25,000, 30,000, 35,000, 40,000, 45,000, or 50,000 N/m and/or not more than 450,000, 417,000, 400,000, 350,000, 300,000, 283,000, 250,000, or 200,000 N/m, while the dry tensile strength in the cross direction normalized for thickness can be at least 3000, 4000, 5000, 6000, 7000, 8000, 9000, 10,000, 11,000, 12,000, 13,000, 14,000, or 15,000 N/m and/or not more than 400,000, 350,000, 300,000, 250,000, 200,000, 150,000, 100,000, 75,000, or 50,000 N/m, measured according to NWSP 100.4 Option A.

When normalized for the bulk density, the nonwoven web and/or the articles produced herein may have a wet tensile strength in the machine direction of at least 0.01, 0.05, 0.07, 0.10, 0.12, 0.15, 0.20, 0.25, 0.30, 0.35, 0.40, 0.45, 0.50, 0.54, or 0.55 Nm³/kg and/or not more than 2.0, 1.9, 1.8, 1.7, 1.6, 1.5, 1.4, 1.3, 1.2, 1.1, 1.0, 0.9, 0.8, 0.7, 0.6, 0.5, 0.4, or 0.3 Nm³/kg, measured according to NWSP 110.4 Option A. Additionally, the nonwoven web and/or the articles produced herein may have a wet tensile strength in the cross-direction, normalized for the bulk density of the nonwoven, of at least 0.01, 0.02, 0.05, 0.07, 0.10, 0.12, 0.15, 0.20, 0.25, 0.30, 0.35, 0.40, 0.45, 0.50, 0.54, or 0.55 Nm³/kg and/or not more than 2.0, 1.9, 1.8, 1.7, 1.6, 1.5, 1.4, 1.3, 1.2, 1.1, 1.0, 0.90, 0.80, 0.70, 0.60, 0.56, 0.50, 0.40, or 0.3 Nm³/kg, measured according to NWSP 110.4 Option A.

The dry tensile strength in the machine direction, normalized according to bulk density of the nonwoven, may be at least 0.01, 0.02, 0.05, 0.07, 0.10, 0.12, 0.15, 0.20, 0.25, 0.30, 0.35, 0.40, 0.45, 0.50, 0.55, or 0.60 Nm³/kg and/or not more than 5, 4.5, 4, 3.5, 3.4, 3, 2.5, 2, 1.5, 1, 0.5, or 0.3 Nm³/kg, while the dry tensile strength in the cross direction normalized for basis weight can be at least 0.01, 0.02, 0.05, 0.07, 0.10, 0.12, 0.15, 0.18, 0.20, 0.25, 0.30, 0.35, 0.40, 0.45, 0.50, 0.55, or 0.60 Nm³/kg and/or not more than 2.0, 1.9, 1.8, 1.7, 1.6, 1.5, 1.4, 1.3, 1.2, 1.1, 1.0, 0.90, 0.80, 0.70, 0.60, 0.56, 0.50, 0.40, or 0.3 Nm³/kg, measured according to NWSP 100.4 Option A.

In one embodiment or in any of the mentioned embodiments, the wet bondability index (BI₂₀) of the nonwoven web and/or the articles produced herein can be at least 0.1, 0.2, 0.5, 1, 2, 2.5, 5, 6, 7, 8, 9, 10, 11, 12, or 13 and/or not more than 30, 29, 28, 27, 26, 25, 24, 23, 22, 21, 20, 19, 18, 17, 16, 15, 14, 13, 12, 11, 10, 9, 8, 7, 6, 5, or 4. The dry bondability index of the nonwoven can be at least 0.1, 0.5, 1, 2, 2.5, 3, 4, 5, 6, 7, 8, 9, 10, 12, 15, 17, or 20. Alternatively, or in addition, the dry bondability of the nonwoven web and/or the articles produced herein can be no more than 50, 45, 40, 35, 30, 25, 20, 15, or 10. The bondability index of the nonwoven is defined as the square root of the product of the tensile strength in the machine direction and the tensile strength in the cross direction. The calculated bondability index is multiplied by 20 and divided by the actual base weight in g/m² to report bondability index in standard nonwovens base weight of 20 g/m² (BI₂₀). The wet and dry tensile strengths are measured as described herein.

Additionally, or in the alternative, the nonwoven web and/or the articles produced herein may have an absorbency of at least 300 percent (3 grams of water per gram of fiber). In other embodiments, the nonwoven web and/or the articles produced herein may have an absorbency of at least 400, 450, 500, 550, 600, 650, 700, 750, 800, 850, 900, 950, 1000, 1050, 1100, or 1150 percent, or at least 4, 4.5, 5, 5.5, 6, 6.5, 7, 7.5, 8, 8.5, 9, 9.5, 10, 10.5, 11, or 11.5 grams of water per gram of fiber.

In one embodiment or in any of the mentioned embodiments, the nonwoven web and/or the articles produced herein may have an absorbency of not more than 2500, 2400, 2300, 2200, 2100, 2000, 1950, 1900, 1850, 1800, 1750, 1700, 1650, 1600, 1550, 1500, 1450, 1400, 1350, 1300, 1250, 1200, or 1150 percent, or not more than 25, 24, 23, 22, 21, 20, 19.5, 19, 18.5, 18, 17.5, 17, 16.5, 16, 15.5, 15, 14.5, 14, 13.5, 13, 12.5, 12, or 11.5 grams of water per gram of fiber. Absorbency values provided herein are measured as described in NWSP 010.1-7.2.

The nonwoven web may also exhibit desirable wicking properties. For example, in one embodiment or in any of the mentioned embodiments, the nonwoven web and/or the articles produced herein may have a wicking height, measured in the cross or machine direction, at 5 minutes of not more than 200 mm. In some cases, the wicking height of the nonwoven web and/or the articles produced herein can be no more than 200, 175, 150, 125, 100, 95, 90, 85, 80, 75, 70, 65, 60, 55, 50, 45, 40, 35, 30, 25, 20, 15, 10, or 5 mm, measured as described in NWSP 010.1-7.3. Additionally, or in the alternative, the wicking height can be at least 1, 5, 10, or 20 mm, measured as described in NWSP 010.1-7.3.

In one embodiment or in any of the mentioned embodiments, the nonwoven web and/or the articles produced herein may have a wicking height, measured in the machine or cross direction, of at least 1, at least 2, at least 3, at least 5, at least 10, at least 12, at least 15, at least 20, at least 25, at least 30, at least 35, at least 40, at least 45, at least 50, or at least 55 mm, measured as described in NWSP 010.1-7.3. Alternatively, or in addition, the nonwoven web and/or the articles produced herein may have a wicking height, measured in the machine or cross direction, of not more than 70, not more than 65, not more than 60, not more than 55, not more than 50, not more than 45, not more than 40, not more than 35, not more than 30, not more than 25, not more than 20, not more than 15, not more than 12, not more than 10, not more than 8, not more than 5, not more than 3, or not more than 2 mm, measured as described in NWSP 010.1-7.3.

The nonwoven web and/or the articles produced herein may exhibit superior thermal insulation per equivalent unit loft. In one embodiment or in any of the mentioned embodiments, the nonwoven web and/or the articles produced herein can have a clo value per millimeter of loft of at least 0.180, at least 0.185, at least 0.190, at least 0.195, at least 0.2, at least 0.205, at least 0.21, at least 0.215, at least 0.22, at least 0.225, at least 0.23, at least 0.235, at least 0.24, at least 0.245, at least 0.250 and/or not more than 3.0, not more than 2.9, not more than 2.8, or not more than 2.7, in each case as clo/mm.

In one embodiment or in combination with any mentioned embodiments, the nonwoven web and/or the articles produced herein can exhibit superior initial loft per mm. In one embodiment or in combination with any mentioned embodiments, the nonwoven web and/or the articles produced herein can have an initial loft/mm of at least 13 mm, at least 13.5 mm, at least 14 mm, at least 14.5 mm, at least 15 mm, at least 15.5 mm, at least 16 mm, at least 16.5 mm, at least 17 mm, at least 17.5 mm, at least 18 mm, at least 18.5 mm, or at least 19 mm and/or up to 21 mm or up to 20 mm as measured according to ASTM D6571.

In one embodiment or in combination with any mentioned embodiments, the fiber blend and/or the articles containing the cellulose acetate staple fiber can exhibit desirable compression resistance properties. For example, the fiber blend and/or the articles containing the cellulose acetate staple fiber can exhibit a compression resistance of at least 15, at least 15.5, at least 16, at least 16.5, at least 17.0, at least 17.5, at least 18, at least 18.5, at least 19, or at least 19.5 percent and/or not more than 25, not more than 24, not more than 23, or not more than 22 percent as measured according to ASTM D6571.

In one embodiment or in combination with any mentioned embodiments, the fiber blend and/or the articles containing the cellulose acetate staple fiber can exhibit a superior elastic loss. For example, the fiber blend and/or the articles containing the cellulose acetate staple fiber can exhibit an elastic loss after the first compression cycle of at least 25, 26, 27, 28, 29, 30, 31, 32, 33, or 34 percent and/or not more than 50, 45, 40, 39, 38, 37, or 36 percent as measured according to ASTM D6571.

In one embodiment or in combination with any mentioned embodiments, the fiber blend and/or the articles containing the cellulose acetate staple fiber can exhibit a superior short-term compression recovery. For example, the fiber blend and/or the articles containing the cellulose acetate staple fiber can exhibit a short-term compression recovery of at least 50, 51, 52, 53, 54, 55, 56, 57, 58, 59, or 60 percent and/or not more than 75, 70, 69, or 68 percent as measured according to ASTM D6571.

In one embodiment or in combination with any mentioned embodiments, the fiber blend and/or the articles containing the cellulose acetate staple fiber may also exhibit desirable levels of softness and/or opacity. Softness is measured according to the Emtec Tissue Softness Analyzer (TSA) method. In one embodiment or in any of the mentioned embodiments, the hand-feel of the nonwoven web can be at least 104, 104.5, 105, 105.5, 106, 106.25, 106.5, 106.75, 107, 107.25, 107.5, 107.75, or 108, as determined by the TSA method using the QA1 algorithm. Additionally, or in the alternative, the real softness of the nonwoven web and/or the articles produced herein, measured according to the TSA method, can be at least 2, 2.05, 2.10, 2.15, 2.20, 2.25, 2.30, 2.35, 2.40, 2.45, 2.50, 2.55, 2.60, 2.65, 2.70, 2.75, 2.80, 2.85, 2.90, 2.95, 3, 3.05, 3.1, 3.15, 3.2, 3.25, 3.3, 3.35, or 3.4 dB and/or not more than 6, 5.75, 5.5, 5.25, 5.0, 4.75, 4.50, 4.45, 4.40, 4.35, 4.30, 4.25, 4.20, 4.15, 4.10, 4.05, 4.0, 3.95, 3.90, 3.85, 3.80, 3.75, 3.7, 3.65, 3.6, 3.55, 3.5, or 3.45 dB.

In one embodiment or in any of the mentioned embodiments, the roughness of the nonwoven web and/or the articles produced herein can be at least 1, 2, 5, 8, 10, 12, 12.5, 13, 13.5, 14, 14.5, 15, 15.5, 16, 16.5, 17, 17.5, 18, 18.5, or 19 dB and/or not more than 30, 28, 25, 24, 22.5, 22, 21.5, 21, 20.5, 20, 19.5, 19, 18.5, 18, 17.5, 17, 16.5, 16, 15.5, 15, 14.5, or 14 dB. The web roughness measured according to the TSA method correlates to the vertical vibration of the tissue sample itself caused by the horizontal motion of the blade and the surface structure.

The opacity of a nonwoven web may be measured according to the procedure described in NWSP 060.1.R0. The nonwoven web and/or the articles produced herein according to the present disclosure may have an opacity of at least 40, 45, 50, 55, 60, 65, 70, 75, 80, 85, 90, 95, or up to 100 percent. Alternatively, or in addition, the nonwoven web and/or the articles produced herein may have an opacity of not more than 95, 90, 85, 80, 75, 70, 65, 60, or 55 percent, measured according to the above procedure.

In one embodiment or in any of the mentioned embodiments, the nonwoven web and/or the articles produced herein can have superior heat-insulating properties for its weight. For example, the webs can have a clo per gsm (or clo/(g/m²)) value of at least 0.030, at least 0.031, at least 0.032, at least 0.033, or at least 0.034 g/m².

The nonwoven webs produced from the cellulose acetate staple fibers or the fiber blends described above can be used to form various articles, such as fill materials for textiles and other filled articles. The fill materials described herein can be used in any application where a fill material, such as an insulation, is utilized. For example, the fill materials may be used as insulation in filled articled and textiles, such as outerwear, sweaters, coats, shirts, fleece, bedding, shoes, gloves, blankets, throws, mattresses, mattress pads, sleeping bags, cushions, comforters, and pillows. The textiles containing the fill materials described herein can exhibit superior loft, compression recovery, insulation, and soft hand. The filled articles can comprise an outer fabric layer, wherein the fill material may be disposed within this outer fabric layer.

It is contemplated that any ingredient, component, or step that is not specifically named or identified as part of the present invention may be explicitly excluded.

To remove any doubt, the present invention includes and expressly contemplates and discloses any and all combinations of embodiments, features, characteristics, parameters, and/or ranges mentioned herein. That is, the subject matter of the present invention may be defined by any combination of embodiments, features, characteristics, parameters, and/or ranges mentioned herein.

### DEFINITIONS

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the phrase “at least a portion” includes at least a portion and up to and including the entire amount or time period.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “not limiting” or “not limiting to” have the same open-ended meaning as “comprising,” “comprises,” and “comprise” provided above.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

As used herein, the term “predominantly” means more than 50 percent by weight.

As used herein, a “fill material” refers to a bonded and/or unbonded material that is added to a textile, yarn, and/or fabric to fill in open spaces and/or change weight.

As used herein, “insulation” refers to a material filler that affects thermal/heat, sound, moisture, and/or electrical transmission.

As used herein, “fiber blend” refers to mixture of two or more different fibers. For example, a fiber blend can comprise two or more of the fibers described herein.

As used herein, “blending process” refers to any process to blend two or more fibers, including but not limited to web, sliver, blown or air drum, roving, ring, ribbon lap, combing, mixing, stirring, or draw frame related blending processes.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

When a numerical sequence is indicated, it is to be understood that each number is modified the same as the first number or last number in the numerical sequence or in the sentence, e.g., each number is “at least,” or “up to” or “not more than” as the case may be; and each number is in an “or” relationship. For example, “at least 10, 20, 30, 40, 50, 75 wt. % . . . ” means the same as “at least 10 wt. %, or at least 20 wt. %, or at least 30 wt. %, or at least 40 wt. %, or at least 50 wt. %, or at least 75 wt. %,” etc.; and “not more than 90 wt. %, 85, 70, 60 . . . ” means the same as “not more than 90 wt. %, or not more than 85 wt. %, or not more than 70 wt. % . . . ” etc.; and “at least 1%, 2%, 3%, 4%, 5%, 6%, 7%, 8%, 9% or 10% by weight . . . ” means the same as “at least 1 wt. %, or at least 2 wt. %, or at least 3 wt. % . . . ” etc.; and “at least 5, 10, 15, 20 and/or not more than 99, 95, 90 weight percent” means the same as “at least 5 wt. %, or at least 10 wt. %, or at least 15 wt. % or at least 20 wt. % and/or not more than 99 wt. %, or not more than 95 wt. %, or not more than 90 weight percent . . . ” etc.

### Claims Not Limited to Disclosed Embodiments

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A fiber blend comprising:
(a) a cellulose acetate staple fiber, wherein the cellulose acetate staple fiber has a cut length of at least 55 mm; and
(b) at least 25 weight percent of a silk fiber.

2. The fiber blend according to claim 1, wherein the cellulose acetate staple fiber has a cut length of 64 to 500 mm.

3. The fiber blend according to claim 1, wherein the cellulose acetate staple fiber has a cut length of 95 to 260 mm.

4. The fiber blend according to claim 1-3, wherein the cellulose acetate staple fiber has a denier per filament in the range of 1.2 to 8.

5. The fiber blend according to claim 1, wherein the cellulose acetate staple fiber has a non-round cross-sectional shape.

6. The fiber blend according to claim 1, wherein the cellulose acetate staple fiber has a crimp frequency of 10 to 30 CPI.

7. An insulation material comprising the fiber blend according to claim 1.

8. A fiber blend comprising:
(a) a cellulose acetate staple fiber, wherein the cellulose acetate staple fiber comprises a cut length of greater than 150 mm; and
(b) an optional secondary fiber.

9. The fiber blend according to claim 8, wherein the cellulose acetate staple fiber has a cut length of 210 to 500 mm.

10. The fiber blend according to claim 8, further comprising at least 25 weight percent of the secondary fiber.

11. The fiber blend according to claim 10, wherein the secondary fiber comprises a silk fiber, a cotton fiber, a flax fiber, a rayon fiber, an acrylic fiber, a polyester fiber, a polyamide fiber, a polyolefin fiber, a recycled fiber, a virgin fiber, a biodegradable fiber, a compostable fiber, a staple fiber, a wool fiber, a cellulosic fiber, a hemp fiber, an animal-based fiber, a plant-based fiber, a mineral-based fiber, a synthetic based fiber, or a combination thereof.

12. The fiber blend according to claim 8, wherein the cellulose acetate staple fiber has a denier per filament in the range of 1.2 to 8.

13. An insulation material comprising the fiber blend according to claim 8.

14. A fill material for use in filled articles and/or insulation comprising:
(a) at least 95 weight percent of a cellulose acetate staple fiber, wherein the cellulose acetate staple fiber has a cut length of at least 55 mm,
(b) an optional secondary fiber.

15. The fill material according to claim 14, wherein the cellulose acetate staple fiber has a cut length of 64 to 500 mm.

16. The fill material according to claims 14, wherein the cellulose acetate staple fiber has a cut length of 95 to 260 mm.

17. The fill material according to claim 14, wherein the cellulose acetate staple fiber has a denier per filament in the range of 1.2 to 8.

18. A filled article comprising an outer fabric layer and a fill material disposed within the outer fabric layer, wherein the fill material comprises:
(a) a fiber blend of silk fibers and cellulose acetate staple fibers, wherein the blend comprises at least 25 weight percent of the silk fibers,
(b) a first fiber material comprising at least 95 weight percent of cellulose acetate staple fibers having a cut length of at least 55 mm, and/or
(c) a second fiber material comprising cellulose acetate staple fibers having a cut length of at least 150 mm.

19. The filled article according to claim 18, wherein the filled article comprises a textile.

20. The filled article according to claim 18, wherein the filled article comprises outerwear, bedding, shoes, gloves, pillows, comforters, blankets, throws, mattresses, mattress pads, sleeping bags, cushions, or a combination thereof.
